(19) United States
(12) Patent Application Publication
(10) Pub. No.: US 2024/0035840 A1
(43) Pub. Date: Feb. 1, 2024

(54) LANE INDICATION METHOD, APPARATUS AND DEVICE, AND STORAGE MEDIUM

(71) Applicant: TENCENT TECHNOLOGY (SHENZHEN) COMPANY LIMITED, Shenzhen (CN)

(72) Inventor: Jian ZHAO, Shenzhen (CN)

(21) Appl. No.: 18/487,076

(22) Filed: Oct. 14, 2023

Related U.S. Application Data
(63) Continuation of application No. PCT/CN2022/127627, filed on Oct. 26, 2022.

(30) Foreign Application Priority Data
Dec. 10, 2021 (CN) 202111509509.5

(51) Int. Cl. G01C 21/36; G01C 21/34

(52) U.S. Cl. CPC G01C 21/3658; G01C 21/3673; G01C 21/367; G01C 21/3655; G01C 21/3461; G01C 21/3492

(57) ABSTRACT

A lane indication method includes: in response to a navigation start operation, displaying a navigation interface, where the navigation start operation indicates performing navigation based on a navigation start position and a navigation end position, and the navigation interface is configured to display a navigation route, the navigation route comprising at least one intersection; in response to being within a prompt range of a current intersection, providing lane prompt information corresponding to the current intersection and lane prompt information corresponding to a subsequent intersection of the current intersection.

### CROSS-REFERENCES TO RELATED APPLICATIONS

This application is a continuation application of PCT Patent Application No. PCT/CN2022/127627, filed on Oct. 26, 2022, which claims priority to Chinese Patent Application No. 202111509509.5, entitled “LANE INDICATION METHOD, APPARATUS, DEVICE, STORAGE MEDIUM, AND COMPUTER PROGRAM PRODUCT” filed with the Chinese Patent Office on Dec. 10, 2021, the entire contents of both of which are incorporated herein by reference.

### FIELD OF THE TECHNOLOGY

Embodiments of this disclosure relate to the field of navigation technology, in particular relate to a lane indication method, apparatus and device, a storage medium and a computer program product.

### BACKGROUND

Navigation systems are widely used in in-vehicle terminals. Navigation systems usually include a collection of road functions, including real-time positioning, destination selection, route planning, guidance and the like. Navigation systems provide great convenience for people who travel by driving vehicles.

In related technologies, in the process of driving using a navigation system by a user, the navigation system formulates the target route according to the destination inputted by the user so as to guide the user to drive in accordance with the target route and provide lane information to the user. However, in the above situations, because the navigation system generally only provides an intersection reminder to the user within a designated distance in front of the intersection, there might be a driving error caused by the user's unfamiliarity with road traffic, causing a higher driving error and detour rate.

### SUMMARY

Embodiments of this disclosure provide a lane indication method, apparatus and device, a storage medium, and a computer program product, which can reduce driving detour rate and improving driving safety. The technical solutions are as follows:

According to one aspect, a lane indication method is provided, the method being executed by a terminal device and the method including: in response to a navigation start operation, displaying a navigation interface, where the navigation start operation indicates performing navigation based on a navigation start position and a navigation end position, the navigation interface is configured to display a navigation route, and the navigation route includes at least one intersection; and in response to being within a prompt range of the current intersection, providing lane prompt information corresponding to a current intersection and lane prompt information corresponding to a subsequent intersection of the current intersection.

According to another aspect, a lane indication apparatus is provided, the apparatus including: a display module configured to display a navigation interface in response to a navigation start operation, where the navigation start operation indicates performing navigation based on a navigation start position and a navigation end position, the navigation interface is configured to display a navigation route, and the navigation route includes at least one intersection; and in response to the apparatus being in a prompt range of the current intersection, provide lane prompt information corresponding to a current intersection and lane prompt information corresponding to a subsequent intersection of the current intersection.

According to still another aspect, a computer device is provided, the computer device including at least one processor and at least one memory, where a computer program is stored in the at least one memory and the computer program is loaded and executed by the at least one processor so as to implement the lane indication method described above.

According to yet another aspect, a non-transitory computer readable storage medium is provided, where a computer program is stored in the computer readable storage medium and the computer program is loaded and executed by at least one processor so as to implement the lane indication method described above.

The beneficial effects brought by the technical solution provided by the embodiments of this disclosure at least include: in response to that the location of the terminal is within the prompt range of the current intersection, displaying at the same time the lane prompt information of the current intersection and the lane prompt information of the subsequent intersection to realize the pre-reminder of the lanes of the current intersection and the subsequent intersection during the navigation process, so as to indicate to the user the intersection situation included in the navigation route and the corresponding lane switching requirements, and reduce the user's tendency to lane change errors when encountering continuous intersections during driving conditions, thereby reducing the driving detour rate, and improving the accuracy and fineness of the lane indication function to ensure the driving safety of the user.

### BRIEF DESCRIPTION OF THE DRAWINGS

FIG. 1 is a schematic diagram of a lane indication method provided by an exemplary embodiment of this disclosure;

FIG. 2 is a schematic diagram of an implementation environment provided by an exemplary embodiment of this disclosure;

FIG. 3 is a flow chart of a lane indication method provided by an exemplary embodiment of this disclosure;

FIG. 4 is a flow chart of a lane indication method provided by another exemplary embodiment of this disclosure;

FIG. 5 is a schematic diagram displaying lane prompt information on a navigation interface provided by the embodiment shown in FIG. 4;

FIG. 6 is a schematic diagram displaying lane prompt information of at least two subsequent intersections in a navigation interface provided by the embodiment shown in FIG. 4;

FIG. 7 is a schematic diagram displaying lane prompt information of subsequent intersections according to specified conditions in a navigation interface provided by the embodiment shown in FIG. 4;

FIG. 8 is a schematic diagram of displaying lane prompt information according to a driving speed in the navigation interface provided by the embodiment shown in FIG. 4;

FIG. 9 is a flow chart of a lane indication method provided by another exemplary embodiment of this disclosure;

FIG. 10 is a schematic diagram corresponding to an enlarged display logo provided based on the embodiment shown in FIG. 9;

FIG. 11 is a schematic diagram corresponding to a bubble prompt box provided based on the embodiment shown in FIG. 9;

FIG. 12 is a schematic diagram of a prompt box display provided based on the embodiment shown in FIG. 9;

FIG. 13 is a schematic diagram of another prompt box display provided based on the embodiment shown in FIG. 9;

FIG. 14 is a schematic diagram of another prompt box display provided based on the embodiment shown in FIG. 9;

FIG. 15 is a schematic diagram of another prompt box display provided based on the embodiment shown in FIG. 9;

FIG. 16 is a schematic diagram of a lane indication method provided by another exemplary embodiment of this disclosure;

FIG. 17 is a structural diagram of a lane indication apparatus provided by an exemplary embodiment of this disclosure;

FIG. 18 is a structural diagram of a lane indication apparatus provided by another exemplary embodiment of this disclosure;

FIG. 19 is a structural block diagram of a computer device provided by an exemplary embodiment of this disclosure.

### DESCRIPTION OF EMBODIMENTS

### Embodiments

First, the nouns involved in the embodiments of this disclosure are briefly introduced:

Traffic Guidance System (TGS): formulate a planning route according to the navigation start position and navigation end position inputted using a navigation software by a user, and provide the user with the optimal path for guidance, or help the user find the optimal path from the navigation start position to the navigation end position by obtaining real-time traffic information, for example: avoiding the path of the congested road section.

Intelligent Traffic System (ITS), also known as the Intelligent Transportation System, effectively and comprehensively applies advanced science and technology (information technology, computer technology, data communication technology, sensor technology, electronic control technology, automatic control theory, operations research, artificial intelligence, etc.) to transportation, service control and vehicle manufacturing to strengthen the connection among vehicles, roads, and users, thereby forming a comprehensive transportation system that guarantees safety, enhances efficiency, improves the environment, and saves energy.

Intelligent Vehicle Infrastructure Cooperative Systems (IVICS), abbreviated Vehicle Infrastructure Cooperative Systems (VICS), is a development direction of the Intelligent Transportation system (ITS). VICS uses advanced wireless communication and new generation of Internet technologies to implement dynamic real-time information interaction of vehicles and vehicle-infrastructure in all aspects, and carry out vehicle active safety control and road collaborative management based on the acquisition and integration of all-time and all-space dynamic traffic information to fully realize the effective collaboration of people, vehicles and roads, ensure traffic safety, and improve the efficiency of traffic, thus forming a safe, efficient and environmentally friendly road traffic system.

In related technologies, taking in-vehicle navigation as an example, in response to that lane reminders are required during the navigation process of in-vehicle navigation, the in-vehicle terminal generally displays, on the navigation interface, the driving lane corresponding to the current intersection, for example: when there is a need to go straight at the current intersection, prompt information is correspondingly displayed so as to instruct the user to drive on the lane corresponding to straight driving. However, when the distance between the intersections is relatively close, because the user cannot learn the lane driving scheme in the next intersection in time after passing the current intersection, it makes it impossible for the user to drive to the correct lane in time, thus leading to low navigation success rate and causing safety problems.

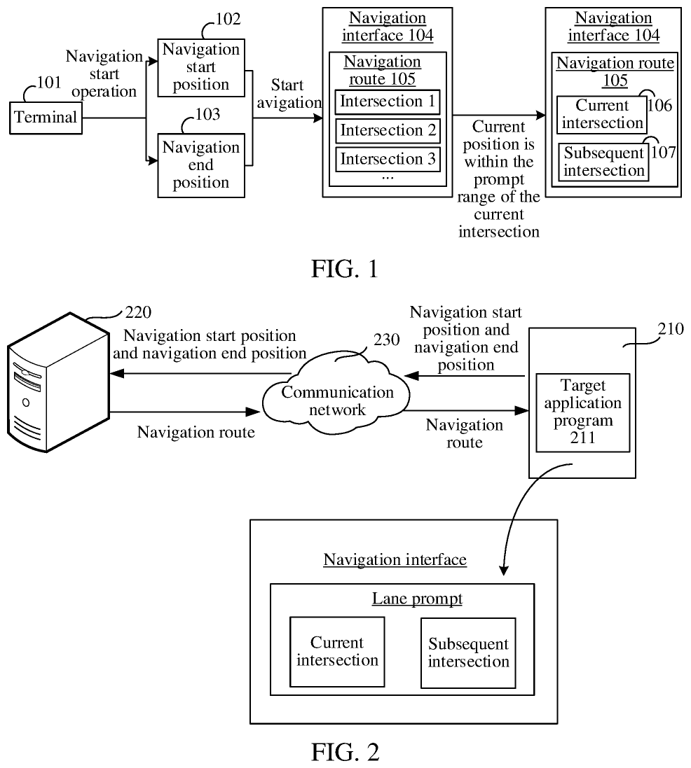

In the embodiments of this disclosure, regarding lane reminders, in addition to performing prompts on the lanes at the current intersection, the lane reminders will also perform synchronous prompts on the subsequent intersections at the current intersection, thereby increasing the navigation success rate. Illustratively, FIG. 1 shows a schematic diagram of a lane indication method provided by an exemplary example of this disclosure; as shown in FIG. 1, a terminal 101 responds to the navigation start operation and displays a navigation interface 104, the navigation start operation being used for navigation based on a navigation start position 102 and a navigation end position 103.

In the process of displaying the navigation interface 104, the terminal 101 displays a navigation route 105 on the navigation interface 104. The navigation route 105 is a route determined based on the navigation start position 102 and the navigation end position 103. The navigation route 105 includes at least one intersection. In response to the current location of the terminal 101 being within the prompt range of the current intersection 106, the terminal 101 provides lane prompt information corresponding to the current intersection 106 and lane prompt information corresponding to the subsequent intersection 107 of the current intersection 106, the lane prompt information being used for lane prompting. For example, the lane prompt information indicates the driving direction of the user at the intersection, the location of the lane corresponding to the driving direction at the intersection, the distance between the subsequent intersection 107 and the terminal 101, and the like.

Combined with the above introduction, the application scenarios of the embodiments of this disclosure are exemplified:

1. Application in In-Vehicle Navigation Scenarios

The in-vehicle terminal displays the navigation interface, the navigation route determined by the current position and navigation end position based on the in-vehicle terminal is displayed on the navigation interface, and the navigation route includes at least one intersection. When the vehicle is driven to be within the corresponding prompt range of the current intersection (for example: when it is within 50 meters at the current intersection), the in-vehicle terminal displays the lane prompt information corresponding to the current intersection on the navigation interface, for example: display on the navigation interface the content, “Turn left at the intersection in the front, and it is recommended to take the first lane on the left”; in addition, the in-vehicle terminal also displays synchronously, in the navigation interface, the lane prompt information corresponding to the subsequent intersection of the current intersection. Take the lane prompt information corresponding to the next intersection of the current intersection as an example, for example: the in-vehicle terminal also synchronously displays the content “go straight at the next intersection, and it is recommended to take the two lanes in the middle” on the navigation interface.

2. Application in Autonomous Driving Scenarios

The user starts the autonomous driving by means of the autonomous driving system in the vehicle. At the same time, the navigation interface of the in-vehicle terminal displays the navigation route corresponding to the navigation start position to the navigation end position. The navigation route includes at least one intersection. During the process of autonomous driving, when the vehicle is located within the prompt range of the current intersection, the lane prompt information corresponding to the current intersection is voice broadcast, for example: “turn left at the intersection in the front, and it is recommended to take the first lane on the left”; in addition, the in-vehicle terminal also synchronizes the voice broadcast of the lane prompt information corresponding to the subsequent intersection of the current intersection. Take the lane prompt information corresponding to the next intersection of the current intersection by voice broadcast as an example, for example: the in-vehicle terminal also synchronizes the voice broadcast of “go straight at the next intersection of the current intersection, and it is recommended to take the two lanes in the middle.”

Notably, the application scenarios described above are only illustrative examples, which is not limited in the embodiments of this disclosure.

Illustratively, FIG. 2 shows an implementation environment schematic diagram provided by an exemplary example of this disclosure. As shown in FIG. 2, the implementation environment includes a terminal 210 and a server 220, the terminal 210 and the server 220 being connected by means of a communication network 230.

A client of a target application program 211 having navigation functions is mounted and operated in the terminal 210. The target application program 211 can be a navigation application program, an instant communication application, a navigation mini-program, or the like, where the navigation mini-program can be a mini-program where any application program serves as the host program, which is not limited in the embodiments of this disclosure.

After determining a navigation start position and a navigation end position, the terminal 210 sends to a server 220 the navigation start position and the navigation end position, the server 220 performs route planning according to the navigation start position and the navigation end position received so as to generate a navigation route and feedback the navigation route to the terminal 210, the terminal 210 displaying the navigation route on the navigation interface. While displaying the navigation route, the terminal 210 will also perform lane prompting on the intersections in the navigation route. Moreover, in the embodiments of this disclosure, in the process of lane prompting, the terminal 210 will at the same time display lane prompt information of at least two intersections (e.g., the current intersection and subsequent intersections of the current intersection).

The terminal 210 can be at least one of smartphones, tablets, portable laptops, desktop computers, smart speakers, smart wearable devices, in-vehicle terminals, smart voice interactive devices, smart appliances and other terminals. The terminal in the embodiments of this disclosure can also be called a terminal device. In some embodiments, the terminal 210 and the server 220 can be realized as the above-mentioned traffic guidance systems, intelligent traffic systems, intelligent vehicle infrastructure cooperative systems, and so on.

In some embodiments, The communication network 230 mentioned above can be realized as a wired network or a wireless network, and the communication network 230 can be realized as any one of a local area network, urban area network, and wide area network, which is not limited in the embodiments of this disclosure.

The server 220 mentioned above can be realized as a cloud server in the cloud, where the cloud server refers to a server using Cloud technology. Cloud technology refers to hosting technology by unifying a series of resources such as hardware, software, and network in the wide area network or local area network so as to achieve computing, storage, processing and sharing of data. Cloud technology is a general term of network technology, information technology, integration technology, management platform technology, application technology, etc. based on cloud computing business model applications, and it can form a resource pool, which is used on demand and flexible and convenient. Cloud computing technology can become important support. The background services of a technology network system require a large number of calculations and storage resources, such as video websites, picture websites, and more portal websites. With the rapid development and application of the Internet industry, each item may have its own identification mark in the future, which needs to be transmitted to a background system for logical processing. Data of different levels are processed separately, and all kinds of industry data need to be supported by powerful systems. And this can only be realized by cloud computing.

In some embodiments, the server 220 described above can also be implemented as a node in a blockchain system. Blockchain is a new application model of computer technologies such as distributed data storage, point-to-point transmission, consensus mechanism, and encryption algorithm. Blockchain, essentially a decentralized database, is a series of data blocks correspondingly generated using cryptographic methods. Each data block contains a batch of network transaction information used for verifying the validity of its information (anti-counterfeiting) and for generating a next block. The blockchain can include a blockchain underlying platform, a platform product service layer, and an application service layer.

In the embodiments of this disclosure, the lane indication method provided in the server 220 is implemented as a business service in the application service layer.

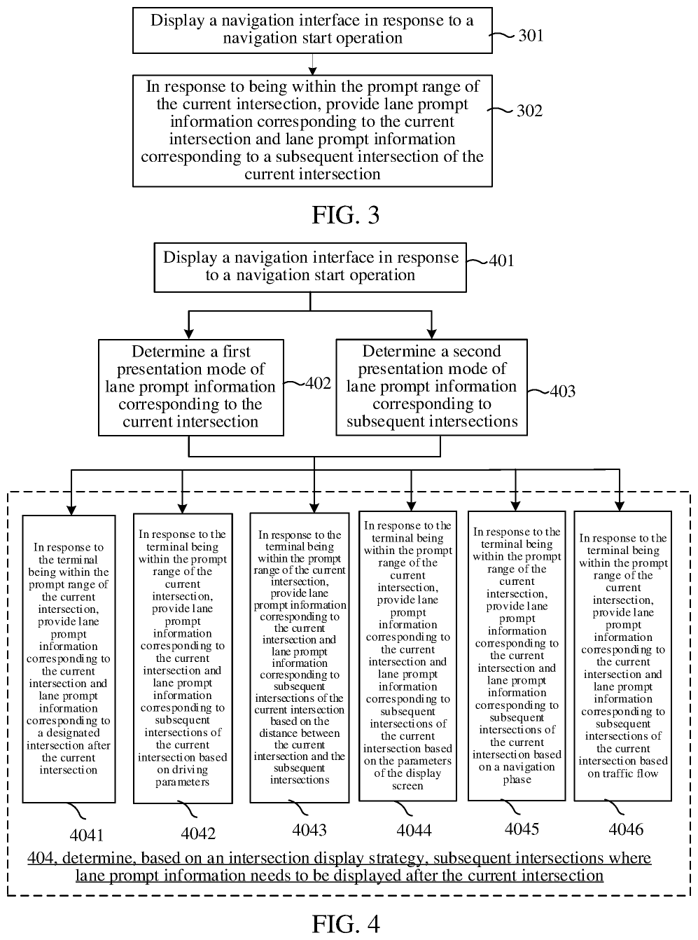

Combining the noun introduction, application scenarios and implementation environment described above, the lane indication method provided by the embodiments of this disclosure will be described, and the method executed by the client mounted and operated in the terminal will be taken as an example. The terminal may correspond to a vehicle that needs navigation. The terminal may be embedded in the vehicle or a separate device placed in the vehicle for navigation. Schematically, FIG. 3 shows a flow chart of a lane indication method provided in an exemplary embodiment of this disclosure. The method may include the following steps:

step 301: in response to a navigation start operation, displaying a navigation interface.

The navigation start operation indicates performing navigation based on a navigation start position and a navigation end position. Schematically, the client in the terminal detects the navigation start operation. When the navigation start operation for the user interface of the client by the user is detected, the client displays the navigation interface, and the navigation start operation can be used for instructing the client to generate a navigation route based on the navigation start position and the navigation end position so as to perform navigation. The navigation start operation described above is used for starting navigation; it can refer to an input operation of the navigation start position and the navigation end position, or can refer to a start operation of the target application program above described, which is not limited in the embodiments of this disclosure. The navigation start position can refer to the starting position of navigation, and the navigation end position can refer to the end position of navigation.

In some embodiments, the means for determining the navigation start position can include at least one of the following:
1.1 according to the positioning function of the terminal, the client determines the current position of the terminal as the navigation start position by default;
1.2 in response to a start position editing operation, the client takes the navigation starting point determined by the start position editing operation as the navigation start position, and the start position editing operation is used for editing or selecting the navigation starting point;
1.3 in response to a voice input operation, the client determines the navigation start position according to a voice input signal corresponding to the voice input operation, the voice input operation being used for inputting the navigation starting point; schematically, the client receives the voice input signal “use the current location as the navigation starting point”, and then the client takes the current location positioned as the navigation start position;
1.4 in response to a shortcut selection operation, the client determines the location point corresponding to the shortcut selection operation as the navigation start position, and the shortcut selection operation is used for using the preset location point as the navigation start position. For example: the location point corresponding to the keyword “home” is preset, and when a selection operation of the keyword “home” is received, the client determines the location point corresponding to “home” as the navigation start position.

In some embodiments, the means for determining the navigation end position can include at least one of the following:
2.1 in response to an end position editing operation, the client uses the navigation ending point determined by the end position editing operation as the navigation end position, the end position editing operation being used for editing or selecting the navigation ending point;
2.2 in response to a voice input operation, the client determines the navigation end position according to a voice input signal corresponding to the voice input operation, the voice input operation being used for inputting the navigation ending point; schematically, if the voice input signal “navigate to the east gate of park A” is received, the client will use the east gate of park A as the navigation end position;
2.3 in response to a shortcut selection operation, the client determines the location point corresponding to the shortcut selection operation as the navigation end position, the shortcut selection operation being used for using the preset location point as the navigation end position, for example: presetting location point corresponding to the keyword “company”, and determining the location point corresponding to the “company” as the navigation end position when the selection operation of the keyword “company” is received;
2.4 in response to the user's calling operation on the positioning information link in other applications, the client uses the location point corresponding to the positioning information link as the navigation end position;
2.5 in response to the user's selection operation on the recommended navigation ending point displayed on the user interface, the client determines the recommended navigation ending point selected by the user as the navigation end position. For example: the user interface displays candidate navigation ending points such as A park, B playground, and C shopping mall, and the client determines the navigation end position according to the selection operation for the candidate navigation ending points.

Notably, the navigation start position and the navigation end position described above are only illustrative examples, which is not limited in the embodiments.

After determining the navigation start position and the navigation end position, the client directly determines the navigation route corresponding to the navigation start position and the navigation end position and starts navigation; or the client displays at least one recommended navigation route corresponding to the navigation start position and the navigation end position, and when a determination operation for one of the navigation routes is received, the client performs navigation according to the navigation route corresponding to the determination operation.

The navigation interface refers to a display interface of the navigation information. The navigation interface can be configured to display a navigation route, and the navigation route includes at least one intersection. In some embodiments, the navigation interface further includes: estimated end time of navigation, estimated travel time of navigation, road congestion, etc. The navigation route mentioned above can be used for guiding the user to drive from the navigation start position to the navigation end position, and the navigation route is the route that the user refers to when driving currently.

In one embodiment, at least one of the intersections described above can be implemented as: at least one of intersections where traffic lights are located, turning intersections, fork intersections, and intersections where road marking lines are located. The intersections where traffic signal lights are located include intersections where traffic light is located, intersections where warning light is located, etc.; turning intersections include sharp turning intersections and U-turn intersections located on roads (such as mountain roads, highways, etc.); fork intersections include merging intersections, diverging intersections (such as high-speed exits), crossing roads (such as T-junctions, crossroads, etc.), etc.; the intersection where road marking lines are located include intersections where pedestrian crossing lines are located, intersections where speed bumps are located, etc., which is not limited in the embodiments of this disclosure.

In some embodiments, the intersection displayed on the current navigation interface is determined by the map range in the navigation interface. In the embodiments of this disclosure, the navigation route between the navigation start position and the navigation end position pass through at least two intersections along the way. No intersection may be displayed on the current navigation interface; or the current intersection is displayed on the current navigation interface; or a plurality of intersections are displayed on the current navigation interface. The displayed number of intersections is related to the range of the map accommodated in the navigation interface, that is, the displayed number of intersections is related to the scaling display ratio of the map in the navigation interface. The larger the scaling of the map (that is, the map is zoomed in), the smaller the area that can be displayed on the navigation interface, and the navigation interface may not be able to display the current intersection or only the current road; The smaller the scaling of the map (that is, the map is zoomed out), the larger the area that can be displayed on the navigation interface, and the current intersection and multiple subsequent intersections can be displayed on the navigation interface.

The scaling of the map is preset, or the scaling of the map is manually adjusted; alternatively, the scaling of the map is correspondingly adjusted in real time according to the distance between the current position of the terminal and the navigation end position, which is not limited in the embodiments of this disclosure.

In some embodiments, the navigation route includes at least one continuous intersection, where the continuous intersection may refer to an intersection where the distance between two adjacent intersections meets the distance requirement. Schematically, the first intersection and the second intersection are two adjacent intersections in the navigation route, and when the distance between the first intersection and the second intersection is less than a distance threshold, it can be determined that the first intersection and the second intersection are continuous intersections.

In some embodiments, the distance between two intersections includes any one of a straight-line distance and a route distance, where the straight-line distance between two intersections refers to the length of the connecting line between the geographic locations of the two intersections; the route distance between two intersections is the total length traveled along the road from the first intersection to the second intersection.

Alternatively, the continuous intersections may also refer to any two adjacent intersections, that is, after passing the first intersection, the next intersection to be passed is the second intersection, then the first intersection and the second intersection are continuous intersections.

Step 302, in response to (e.g., the terminal) being within the prompt range of the current intersection, providing lane prompt information corresponding to the current intersection and lane prompt information corresponding to a subsequent intersection of the current intersection.

The lane prompt information is used for lane prompting, which can indicate the driving direction at the intersection for the user, the location of the lane corresponding to the driving direction at the intersection, the distance between the subsequent intersections and the terminal, and the like. The subsequent intersections refer to the intersections that need to be crossed in the subsequent navigation process after crossing the current intersection on the navigation route. In some embodiments, the subsequent intersection includes at least one intersection after the current intersection in the navigation route.

The prompt range indicates the timing for providing lane prompt information, which can be adaptively set and adjusted. Schematically, when the distance between the terminal and the current intersection is within the prompt range, lane prompt information is provided. For example: assuming that the prompt range is 50 meters, when the user travels to a location within meters from the current intersection, the client will provide lane prompt information.

The distance between the terminal and the current intersection includes any one of a straight-line distance and a route distance. The straight-line distance between the terminal and the current intersection refers to the length of the connecting line between the terminal and the geographic location of the current intersection; The route distance between the terminal and the current intersection refers to the total travel length when traveling from the current position of the terminal to the current intersection along the navigation route.

In some embodiments, the lane prompt information may be advanced auxiliary information provided for the intersection and indicates the intersection situation in advance, so as to help the user or the autonomous driving system understand the driving needs at the intersection in advance and make driving decisions in time. In some embodiments, the lane prompt information can also be driving decision-making auxiliary information provided for the intersection, which is used for prompting the lane distribution information at the intersection in advance; the lane prompt information may also be lane selection auxiliary information provided for navigation routes and intersections, which is used for prompting the user or the autonomous driving system to select lanes at intersections.

Schematically, the lane prompt information can be used for indicating the lane pointing information corresponding to the intersection; alternatively, the lane prompt information can be used for indicating the recommended lane information corresponding to the intersection and the navigation route; alternatively, the lane prompt information can also be used for indicating the distance between the intersection and the designated location; alternatively, the lane prompt information can also be used for indicating the lane flow at the intersection; alternatively, the lane prompt information may also be used for indicating a speed limit requirement at an intersection, etc., which is not limited in the embodiments of this disclosure.

The lane pointing information refers to the lane distribution information corresponding to the intersection. Schematically, the intersection includes four lanes, which are respectively: a first lane-left-turn lane, a second lane-straight lane, a third lane-straight lane, and a fourth lane-right-turn lane; the distribution of the four lanes is the lane pointing information. The lane pointing information facilitates the user to understand the lane distribution corresponding to the intersection in advance before the intersection, so that the user can choose a suitable lane for driving, which improves the effectiveness and rationality of information interaction, thereby improving the rationality and success rate of driving.

The recommended lane information indicates the recommended lane corresponding to the intersection (including the current intersection and the subsequent intersections) in the navigation route, for example: if it is necessary to turn right at the intersection in the navigation route, the recommended lane information is the fourth lane corresponding to the right turn. The recommended lane information facilitates the user to quickly understand the lane that needs to be changed when passing through the intersection during driving, so that the user can change lanes in advance, thereby improving driving safety and reducing driving detour rate.

The distance between the intersection and the specified location includes: the distance between the intersection and the current location of the terminal; or the distance between the intersection and an adjacent intersection. Schematically, when the terminal is located within the prompt range of the current intersection, and the distance between the current location of the terminal and the geographic location of the intersection is 50 meters, the road prompt information at the current intersection includes “the distance from the intersection ahead is 50 meters”. In the case of changing lanes or turning through an intersection, it is convenient for the user to understand the distance between the current location of the terminal and the current intersection during driving, so that the user can change lanes or turn through the intersection within a safe distance. Alternatively, the road prompt information includes “the distance between the intersection ahead and the next intersection is 50 meters”, so as to remind the user to pay attention to the next intersection in advance, thereby further improving driving safety.

The lane flow status refers to the real-time traffic flow corresponding to the lane. Schematically, the lane flow status indicates the real-time traffic flow at the intersection, so that the user can grasp the corresponding intersection flow condition (smooth or congested) in advance, facilitating the user to change routes in time during the driving process and reduce the occurrence of traffic jams, thereby improving the user driving experience.

The speed limit requirement refers to the maximum driving speed for driving through the intersection. For example: if the lane prompt information corresponding to the intersection is “the current intersection speed limit is 60 km/h”, the maximum speed for the user to drive through the current intersection is 60 km/h, thus facilitating the user to adjust the speed in time according to the speed limit requirement of the intersection during driving and reduce the risks of traffic accidents.

In some embodiments, the lane prompt information corresponding to the current intersection includes at least one of the information types described above; the lane prompt information corresponding to the subsequent intersection includes at least one of the information types described above, and the lane prompt information corresponding to the current intersection and the lane prompt information corresponding to the subsequent intersection contain the same or different or partly the same information types, which is not limited in the embodiments.

Schematically, the lane prompt information corresponding to the current intersection includes lane pointing information and recommended lane information, and the lane prompt information corresponding to the subsequent intersection includes recommended lane information. Thus, the lane prompt information corresponding to the current intersection and the lane prompt information corresponding to the subsequent intersection are the same.

In one embodiment, the means of providing lane prompt information may include display screen display and voice broadcast. Schematically, the lane prompt information can be displayed on the display screen of the terminal in the form of text and symbols, and can also be realized by voice broadcast in real time. The presentation form of the lane prompt information corresponding to the current intersection/subsequent intersection can include at least one of the following forms:
1. displaying, on the navigation interface, the lane prompt information corresponding to the current intersection;
2. displaying, on the navigation interface, the lane prompt information corresponding to the subsequent intersection;
3. presenting the lane prompt information corresponding to the current intersection in the form of voice broadcast;
4. presenting the lane prompt information corresponding to the subsequent intersection in the form of voice broadcast.

The presentation form of the lane prompt information can be any combination of the above forms, for example: display, on the navigation interface, the lane prompt information corresponding to the current intersection, and presenting the lane prompt information corresponding to the subsequent intersection in the form of voice broadcast; or displaying, on the navigation interface, lane prompt information corresponding to the current intersection and lane prompt information corresponding to the subsequent intersection, and presenting the lane prompt information corresponding to the subsequent intersection in the form of voice broadcast. As such, the display flexibility of the navigation prompt information is improved, thereby improving the driving experience of the user. In addition, by means of the voice broadcast, the problem that a user is unable to check the content displayed on the display screen in time when driving through the current intersection can be avoided, the user is enabled to grasp lane conditions of subsequent intersections in advance, and the current navigation interface is simplified, making it convenient for the user to quickly browse the lane prompt information displayed on the navigation interface, thereby further improving driving safety and user driving experience.

Notably, the above-mentioned presentation modes of the lane prompt information corresponding to the current intersection and the subsequent intersections are only illustrative examples, which is not limited in the embodiments.

In one embodiment, when a continuous intersection is realized between the subsequent intersection and the current intersection, the lane prompt information corresponding to the current intersection and the subsequent intersection is displayed. Schematically, the above subsequent intersection is determined by at least one of the following methods:
I. the subsequent intersection is a designated intersection after the current intersection, and the designated intersection may refer to a specified number of intersections, such as one intersection, two intersections, three intersections, etc.; alternatively, the designated intersection is an intersection that meets the specified conditions after the current intersection, such as an intersection that meets the distance requirement, which is not limited in the embodiments of this disclosure;
II. the subsequent intersection is determined based on driving parameters, where the driving parameters may include at least one of driving speed, gear position parameters, body static parameters and other parameters;
III. subsequent intersections are determined based on the intersection positional relationship, where the positional relationship of the intersections may be, for example, the distance between the intersections, the road type formed between the intersections (such as F-type intersections, K-type intersections), etc.;
IV. subsequent intersections are determined based on parameters of the display screen, where the parameters of the display screen may refer to the size of the display screen;
V. subsequent intersections are determined based on the navigation phase, where the navigation phase is one of a plurality of navigation phases divided according to preset division rules, for example: initial phase and end phase of navigation, etc. Different navigation phases may correspond to different fifth numbers.

In one embodiment, in response to the user enabling the advance indication function during the navigation process, the client synchronously provides lane prompt information corresponding to the current intersection and the subsequent intersection. The advance indication function refers to the function of providing in advance the lane prompt information corresponding to the subsequent intersection. When a continuous intersection is realized between the subsequent intersection and the current intersection, the embodiments of this disclosure use the above-mentioned various methods to determine the subsequent intersection, improving the accuracy and comprehensiveness of the determination of the subsequent intersection, thereby improving the display accuracy of the lane prompt information, further reducing the driving detour rate and improving user driving experience.

To sum up, in the method provided by the embodiments of this disclosure, when the location of the terminal is within the prompt range of the current intersection and the lane prompt information of the current intersection and the lane prompt information of the subsequent intersection are simultaneously displayed, pre-reminder of the lanes of the current intersection and subsequent intersections during the navigation process is realized so as to indicate to the user the intersection conditions included in the navigation route and the corresponding lane switching requirements, and to reduce the situation where users encounter continuous intersections during driving and are prone to lane-changing errors, thereby reducing the driving detour rate, and improving the accuracy and fineness of the lane indication function so as to ensure the driving safety of users.

In addition, the presentation form of the above-mentioned lane prompt information can be determined by any combination of display screen display and voice broadcast. Thus, the display flexibility of the navigation prompt information is improved, thereby improving the driving experience of the user. In addition, by means of the voice broadcast, the problem that a user is unable to check the content displayed on the display screen in time when driving through the current intersection can be avoided, the user is enabled to grasp lane conditions of subsequent intersections in advance, and the current navigation interface is simplified, making it convenient for the user to quickly browse the lane prompt information displayed on the navigation interface, thereby further improving driving safety and user driving experience.

In addition, when a continuous intersection is realized between the subsequent intersection and the current intersection, the embodiments of this disclosure use the above-mentioned various methods to determine the subsequent intersection, improving the accuracy and comprehensiveness of the determination of the subsequent intersection, thereby improving the display accuracy of the lane prompt information, further reducing the driving detour rate and improving user driving experience.

In addition, by supporting lane prompt information corresponding to lane pointing information, recommended lane information, the distance between intersections and designated locations, lane flow conditions, speed limit requirements, and other information types, the driving rationality and safety are improved and the driving success rate is increased, thereby improving the user driving experience.

In one embodiment, when the current location corresponding to the terminal is within the prompt range of the current intersection, the number of subsequent intersections of the current intersection can be determined based on various methods. Schematically, FIG. 4 shows a flow chart of a lane indication method provided in an exemplary embodiment of this disclosure. As shown in FIG. 4, the method may include:

Step 401, in response to receiving a navigation start operation, displaying a navigation interface.

The navigation start operation indicates performing navigation based on a navigation start position and a navigation end position, the navigation interface is configured to display a navigation route, and the navigation route includes at least one intersection. Step 401 is the same as introduced in the above embodiments. For the content not described in the embodiments of this disclosure, reference may be referred to the above embodiments. No further detail will be provided herein.

Step 402, determining a first presentation mode of the lane prompt information corresponding to the current intersection.

The presentation mode refers to the presentation mode of the lane prompt information, and the first presentation mode refers to the presentation mode of the lane prompt information corresponding to the current intersection.

In some embodiments, the first presentation mode of the lane prompt information corresponding to the current intersection may be determined based on the information display strategy. The information display strategy refers to a strategy for providing lane prompt information, such as a strategy for indicating the information type (i.e., display content) and presentation form of the lane prompt information. Schematically, the first representation mode may include at least one of the information type and presentation form of the lane prompt information corresponding to the current intersection, where the information type may include at least one of lane pointing information, recommended lane information, the distance between the intersection and the designated location, lane flow conditions, and speed limit requirements, and the presentation form may include at least one of display screen display and voice broadcast.

That is, according to the information display strategy, the combination mode of the two presentation forms, i.e., display screen display and voice broadcast (e.g., displaying lane prompt information on the display screen or voice broadcasting lane prompt information or voice broadcasting lane prompt information while displaying lane prompt information on the display screen), and the information type corresponding to the lane prompt information of the current intersection (e.g., at least one of the above information types) can be determined, where the display screen may refer to a terminal display screen, such as an in-vehicle terminal, a mobile phone, or the like. In some embodiments, according to different information display strategies, the lane prompt information of the current intersection can be displayed in different combinations. The information display strategy may be preset, or the information display strategy may be determined from candidate strategies, which is not limited in the embodiments of this disclosure.

Step 403, determine a second presentation mode of the lane prompt information corresponding to a subsequent intersection.

The subsequent intersection refers to one or more intersections after the current intersection, which are the same as introduced in the above embodiments. No further detail will be provided herein. The second presentation mode refers to the presentation form of the lane prompt information corresponding to subsequent intersections.

In some embodiments, the second presentation mode of the lane prompt information corresponding to subsequent intersections may be determined based on the information display strategy. Schematically, the second presentation mode includes at least one of the information types and presentation forms of the lane prompt information corresponding to subsequent intersections, where the information types include at least one of lane pointing information, recommended lane information, the distance between the intersection and the designated location, lane flow conditions and speed limit requirements, and the presentation forms include at least one of display screen display and voice broadcast.

In some embodiments, the information display strategy can be used for instructing to provide targeted lane prompt information based on specified requirements, for example: the information display strategy can be used for instructing to provide targeted lane prompt information based on the driving needs of the user or road conditions. In some embodiments, the information display policy includes a display strategy targeting safety; alternatively, the information display strategy includes a display strategy targeting driving speed. Schematically, taking the safety target as an example, the user frequently looks at the navigation during driving and cannot observe the road conditions in time, which is likely to cause safety problems, and thus the information display strategy can be set as an instruction: use the recommended lane information as the information type of the lane prompt information, display the lane prompt information of the current intersection in the form of interface display, and present the lane prompt information of the subsequent intersection in the form of voice broadcast, for example: display “Please take the middle lane at the current intersection” on the interface and voice broadcast “Please take the first lane on the left at the next intersection”.

The lane prompt information corresponding to the current intersection is displayed in a first presentation mode, and the lane prompt information corresponding to the subsequent intersection is displayed in a second presentation mode. In this way, according to the information display strategy, the presentation mode of the lane prompt information is determined from various information types and presentation forms, improving the flexibility of providing lane prompt information, as well as the comprehensiveness and rationality of lane prompt information, thereby improving driving safety.

Step 404, based on the intersection display strategy, determine the subsequent intersections that need to display lane prompt information after the current intersection.

The intersection display strategy refers to the strategy of determining the subsequent intersections that need to display lane prompt information according to the intersection prompt requirements, where the intersection prompt requirements are determined based on safety requirements, speed requirements, and timeliness requirements during driving.

In some embodiments, the intersection display strategy is related to at least one of the distribution of intersections in the navigation route, the dynamic parameters of the driving process, and the static parameters of the driving process. The dynamic parameters are parameters that are dynamically updated in real time according to the driving process, and the static parameters are parameters that remain constant during driving.

The intersection display strategy related to the intersection distribution includes determining that the designated intersection is a subsequent intersection that needs to provide lane prompt information; or determine the subsequent intersection that needs to provide lane prompt information by means of the intersection positional relationship; or determine the subsequent intersection that needs to provide lane prompt information by means of the traffic flow. The method for formulating an intersection display strategy according to the intersection distribution can realize the formulation of the intersection display strategy that is most suitable for the navigation route according to different navigation routes, so that the client can make corresponding adjustments to the lane prompt information that needs to provide subsequent intersections in complex routes.

The intersection display strategy related to the dynamic parameters of the driving process includes determining subsequent intersection that need to provide lane prompt information by means of driving parameters, and the driving parameters may refer to the driving parameters of the vehicle where the terminal is located; or determining the subsequent intersection that needs to provide lane prompt information by means of the navigation phase. The method for formulating an intersection display strategy according to the dynamic parameters of the driving process can realize the corresponding adjustment according to the continuous changes of the dynamic parameters in different driving processes, making it convenient for the user to respond in time when encountering unexpected situations during the driving process.

The intersection display strategy related to the static parameters of the driving process includes determining the subsequent intersection that needs to provide lane prompt information by means of the driving parameters; or determining the subsequent intersection that needs to provide lane prompt information by means of the parameters of the display screen. Formulating the intersection display strategy according to the static parameters of the driving process can realize the formulation of a corresponding intersection display strategy according to vehicles having different static parameters, so that the corresponding intersection display strategy can be better adapted to the vehicles, thereby improving the user driving experience.

In some embodiments, the intersection display strategy can be related to the distribution of intersections in the navigation route and the dynamic parameters of the driving process at the same time, can also be related to the dynamic parameters of the driving process and the static parameters of the driving process at the same time, and can also be related to the distribution of intersections in the navigation route, the dynamic parameters of the driving process, and the static parameters of the driving process at the same time, which is not limited in the embodiments of this disclosure. Taking as an example the case in which the intersection display strategy can be related to the intersection distribution in the navigation route and the dynamic parameters of the driving process at the same time, the subsequent intersection that needs to provide lane prompt information can be determined by the designated intersection and driving parameters at the same time.

In some embodiments, different subsequent intersections can be determined according to different intersection display strategies so as to provide lane prompt information. The intersection display strategy can be preset or customized, which is not limited in the embodiments of this disclosure.

The following steps 4041 to 4046 are descriptions of an embodiment corresponding to determining the subsequent intersections, and steps 4041 to 4046 are as follows:

Step 4041, in response to the terminal being within the prompt range of the current intersection, providing lane prompt information corresponding to the current intersection and lane prompt information corresponding to a designated intersection after the current intersection.

In some embodiments, the designated intersection is a preset number of intersections after the current intersection, where the preset number includes one or more; or the designated intersection is an intersection meeting the specified condition after the current intersection.

That is, when the subsequent intersection includes a preset number of intersections after the current intersection, step 4041 includes at least one of the following situations:
1. in response to the terminal being within the prompt range of the current intersection, the client provides lane prompt information corresponding to the current intersection and lane prompt information corresponding to a next intersection of the current intersection;
in one embodiment, in response to the terminal being within the prompt range of the current intersection and the distance between the current intersection and the next intersection is within a distance threshold, the client provides lane prompt information corresponding to the current intersection and lane prompt information corresponding to the next intersection of the current intersection. The distance threshold range is a preset range; or the distance threshold range is determined according to the historical driving data of the terminal.

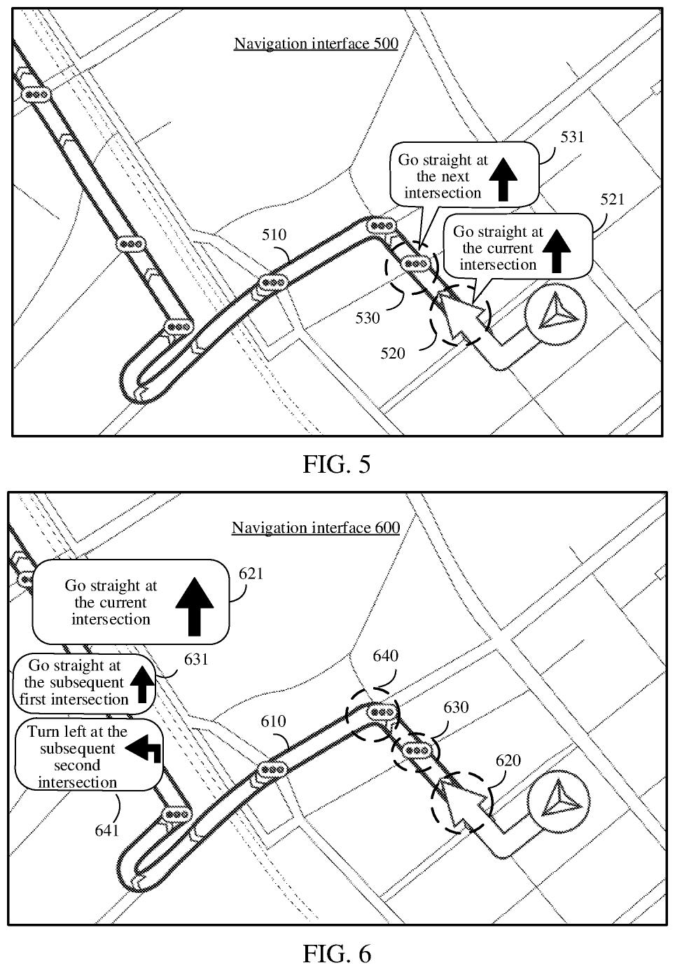

Schematically, please refer to FIG. 5, a navigation route 510 is displayed on a navigation interface 500, and the navigation route 510 indicates that a location 520 within 50 meters from the current position is the current intersection, and there is a need to go straight at the current intersection; the location 530 that is 50 meters behind the current intersection is the next intersection, and there is a need to go straight at the next intersection; thus, the navigation interface 500 displays the lane prompt information 521 corresponding to the current intersection and the lane prompt information 531 corresponding to the next intersection.
2. in response to the terminal being within the prompt range of the current intersection, the client providing lane prompt information corresponding to the current intersection and lane prompt information corresponding to at least two intersections after the current intersection.

The method for determining at least two intersections includes at least one of the following:
the first method: providing lane prompt information corresponding to k sequentially connected intersections after the current intersection, where k is a preset integer and k is greater than 1.

Schematically, taking the value of k being 2 as an example, please refer to FIG. 6, a navigation route 610 is displayed on the navigation interface 600, and the navigation route 610 indicates that the location 620 is the current intersection, and there is a need go straight at the current intersection; the location 630 after the current intersection is the subsequent first intersection, and there is a need to go straight at the subsequent first intersection; the position 640 after the subsequent first intersection is the subsequent second intersection, and there is a need to turn left at the subsequent second intersection; thus, the navigation interface 600 displays the lane prompt information 621 corresponding to the current intersection, the lane prompt information 631 corresponding to the subsequent first intersection, and the lane prompt information 641 corresponding to the subsequent second intersection.

The second method: providing lane prompt information corresponding to m intersections after the current intersection until the first intersection where a turn needs to be made, where the intersection where a turn needs to be made refers to the intersection where a turn needs to be made and a direction needs to be changed at the intersection according to the indication of navigation route, for example: if a left turn needs to be made at the third intersection after the current intersection, the navigation interface will display the lane prompt information corresponding to the first intersection, the second intersection, and the third intersection after the current intersection.

The third method: providing lane prompt information corresponding to p intersections after the current intersection until the first intersection where a lane change needs to be made, where the intersection where a lane change needs to be made refers to driving by changing a lane before/after the intersection according to the indication of navigation route to adapt to the intersection of the navigation route, for example: after the current intersection, there is a need to change from the second lane to the first lane before passing the second intersection, and then the navigation interface displays the lane prompt information corresponding to the first intersection and the second intersection after the current intersection.

Notably, the method for determining at least two subsequent intersections described above are only illustrative examples, an, which is not limited in the embodiments of this disclosure.
3. in response to the terminal being within the prompt range of the current intersection, the client providing lane prompt information corresponding to the current intersection and lane prompt information corresponding to an intersection meeting designated conditions after the current intersection.

The designated intersection refers to the intersection meeting the specified conditions after the current intersection, for example: display lane prompt information corresponding to the current intersection and lane prompt information corresponding to one or more intersections where a turn needs to be made after the current intersection; or display lane prompt information corresponding to the current intersection, and lane prompt information corresponding to one or more intersections where a lane change needs to be made after the current intersection; or display lane prompt information corresponding to the current intersection, and lane prompt information corresponding to the intersection whose distance from the current intersection is within a distance threshold range, which is not limited in the embodiments.

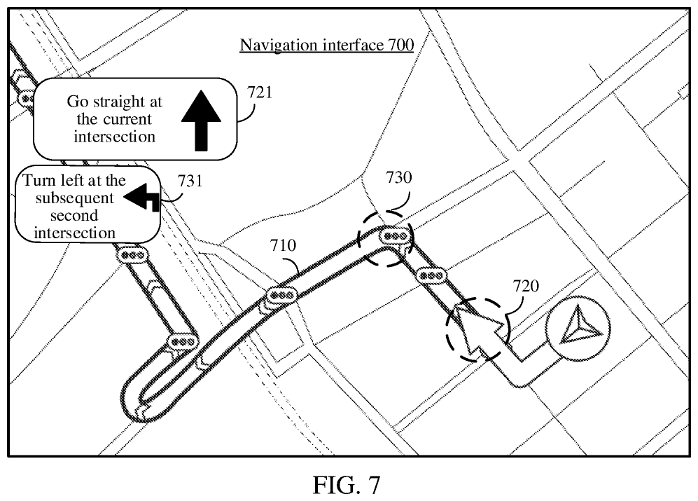

Schematically, please refer to FIG. 7, a navigation route 710 is displayed on a navigation interface 700, and the navigation route 710 indicates that a location 720 within 50 meters from the current location is the current intersection, and there is a need to go straight at the current intersection; the location 730 after the current intersection is the subsequent second intersection, and there is a need to take left at the subsequent second intersection; thus, the navigation interface 700 displays the lane prompt information 721 corresponding to the current intersection, and displays the lane prompt information 731 corresponding to the subsequent second intersection.

Step 4042, in response to the terminal being within the prompt range of the current intersection, providing lane prompt information corresponding to the current intersection and lane prompt information corresponding to subsequent intersections of the current intersection based on driving parameters.

In some embodiments, the driving parameters are driving parameters of a vehicle corresponding to the terminal, and the driving parameters may include at least one of parameters such as a driving speed, a gear parameter, and a static parameter of a vehicle body. In view of the difference in driving parameters, the method for determining subsequent intersections includes at least one of the following:
1. driving parameters include a driving speed;
where based on the driving speed, the client provides lane prompt information corresponding to the current intersection and lane prompt information corresponding to a first number of subsequent intersections after the current intersection. The first number is in a positive correlation relationship with the driving speed.

Since the higher the driving speed, the faster the terminal passes through the intersection, there is a need to provide lane prompting for a larger number of subsequent intersections in advance. That is, the faster the terminal travels, the greater the number of lane prompt information corresponding to the subsequent intersection needs to be provided. In one embodiment, within the number threshold range, the first number is in a positive correlation relationship with the driving speed, that is, when the driving speed reaches a certain level, after the number of lane prompt information corresponding to the subsequent intersection that needs to be provided reaches the number threshold range, the number of subsequent intersections remains unchanged within the maximum number threshold range.

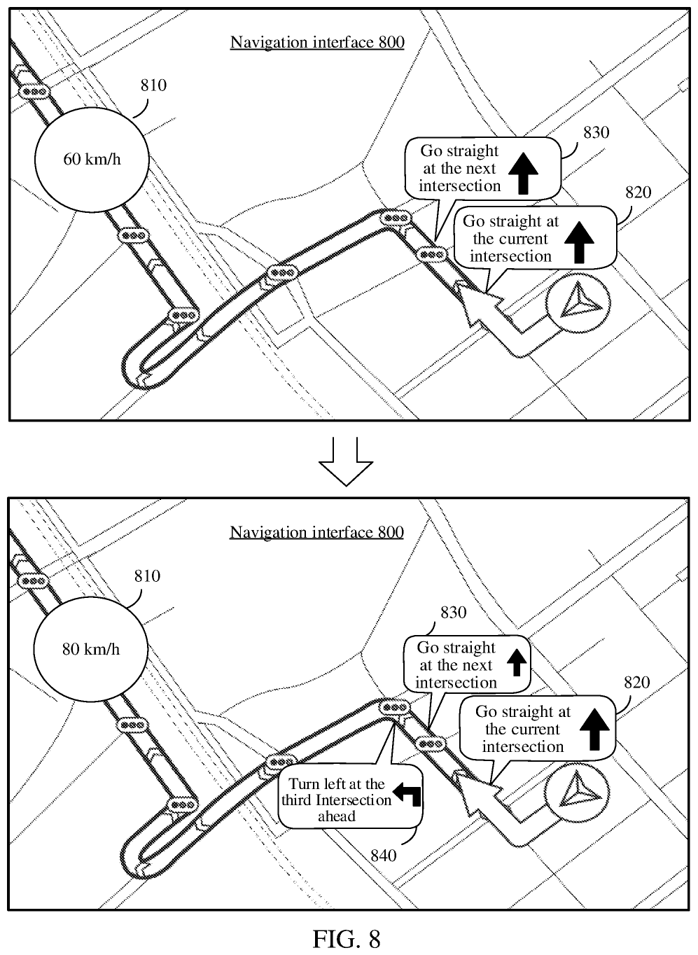

Schematically, please refer to FIG. 8, a speed indication area 810 is displayed on a navigation interface 800. When the current driving speed of the terminal is 60 km/h, the navigation interface 800 displays lane prompt information 820 corresponding to the current intersection, and lane prompt information 830 corresponding to the next intersection; when the current driving speed of the terminal increases to 80 km/h, the navigation interface 800 displays lane prompt information 820 corresponding to the current intersection, lane prompt information 830 corresponding to the next intersection, and lane prompt information 840 corresponding to the subsequent second intersection.
2. the driving parameters include a parameter of a driving gear;
where based on the parameter of the driving gear, the client provides lane prompt information corresponding to the current intersection and lane prompt information corresponding to a second number of subsequent intersections after the current intersection. There is a corresponding relationship between the driving gear and the second number. That is, different parameters of the driving gear correspond to different second numbers.

In some embodiments, the vehicle generally includes an automatic gear (D gear), a sports gear (S gear) and a climbing gear (L gear). In the D gear, the vehicle usually runs at a normal speed on an urban road, for example: 60 km/h; In the S gear, the vehicle usually runs on a smooth road with a high speed limit. In the L gear, the vehicle usually runs on a mountain road, highway and other curved roads. Thus, the second number of subsequent intersections that need to be provided can be determined according to the different driving gears of the vehicle. Schematically, in the D gear, the lane prompt information of the next intersection is displayed; in the S gear, the lane prompt information of two subsequent intersections is displayed; In the L gear, the lane prompt information for three subsequent intersections is displayed.

Notably, the above-mentioned D gears, S gears, and L gears can also be implemented as 3-4 gears, 5-6 gears, and 1-2 gears in manual transmission vehicles respectively.
3. The driving parameters include vehicle body static parameters, for example: Vehicle body length, wheelbase, vehicle type, etc.

Schematically, taking the vehicle type as an example, based on the vehicle type of the vehicle to which the terminal belongs, the client provides lane prompt information corresponding to the current intersection, and lane prompt information corresponding to a second number of subsequent intersections after the current intersection. There is a corresponding relationship between the vehicle type and the second number.

Schematically, when the vehicle type is implemented as a car, the client provides lane prompt information corresponding to the current intersection, and lane prompt information corresponding to the next intersection of the current intersection; when the vehicle type is implemented as passenger car/truck, the client provides lane prompt information corresponding to the current intersection, and lane prompt information corresponding to the two intersections after the current intersection.

Step 4043: in response to the terminal being within the prompt range of the current intersection, providing lane prompt information corresponding to the current intersection and lane prompt information corresponding to the subsequent intersection based on the distance between the current intersection and the subsequent intersection.

In some embodiments, The subsequent intersection is determined based on the intersection location relationship. That is, based on the distance between the current intersection and the subsequent intersection, the client determines a third number of subsequent intersections, and provides lane prompt information corresponding to the current intersection and lane prompt information corresponding to the third number of subsequent intersections.

In some embodiments, the third number of subsequent intersections are determined by at least one of the following methods:
1. determining the subsequent intersection whose distance from the current intersection meets the first distance requirement as one of the third number of subsequent intersections, and provide lane prompt information corresponding to the current intersection, and lane prompt information corresponding to the third number of subsequent intersections that meet the first distance requirement;
schematically, the first distance requirement is within 80 meters, the distance between the next intersection of the current intersection and the current intersection is 30 meters, the distance between the subsequent second intersection of the current intersection and the current intersection is 70 meters, the distance between the subsequent third intersection and the current intersection is 90 meters, then the client provides lane prompt information corresponding to the current intersection, and lane prompt information corresponding to the next intersection and the subsequent second intersection; where the first distance requirement refers to the distance requirement set based on the current intersection;
2. determining, among the current intersection and one or more subsequent intersections, two adjacent intersections whose distance meets the second distance requirement, and including any one of the two adjacent intersections that is not the current interaction to the third number of subsequent intersections, and providing lane prompt information corresponding to the current intersection and lane prompt information corresponding to the third number of subsequent intersections that meet the second distance requirement;
schematically, the second distance requirement is within 50 meters, the distance between the next intersection of the current intersection and the current intersection is 30 meters, the distance between the next intersection and the subsequent second intersection is 40 meters, and the distance between the subsequent second intersection and the subsequent third intersection is 60 meters, then the client provides lane prompt information corresponding to the current intersection, and lane prompt information corresponding to the next intersection and the subsequent second intersection; where the second distance requirement refers to the distance requirement set based on the distance between two adjacent intersections;
when the distance between two adjacent intersections meets the second distance requirement, the two adjacent intersections are implemented as continuous intersections, and when there are at least two groups of continuous intersections, the intersections in the at least two groups of continuous intersections are implemented as a series of continuous intersections, and within the number threshold range of subsequent intersections, the lane prompt information corresponding to the series of continuous intersections is provided; for example: the current intersection and intersection 1 are continuous intersections, intersection 1 and intersection 2 are continuous intersections, intersection 2 and intersection 3 are continuous intersections, intersection 3 and intersection 4 are continuous intersections, then the current intersection, intersection 1, intersection 2, intersection 3, and intersection 4 are a series of continuous intersections; when the client provides lane prompt information corresponding to the current intersection, it synchronously provides lane prompt information corresponding to the intersection 1, intersection 2, intersection 3 and intersection 4 respectively; when the number threshold range of subsequent intersections is 3, the client provides lane prompt information corresponding to the current intersection, and synchronously provides lane prompt information corresponding to the intersection 1, intersection 2 and intersection 3 respectively.

In some embodiments, the first distance requirement or the second distance requirement described above includes a preset distance threshold range; or the first distance requirement or the second distance requirement described above includes a distance threshold range determined according to historical driving data of the terminal, and the first distance requirement and the second distance requirement may be the same or different.

Schematically, the historical driving data correspondingly recorded by the terminal is obtained, where the historical driving data includes the corresponding driving preference, driving duration, historical driving records, etc. during the history driving process. The driving preference includes historical distances from intersections when lane changes are made during historical driving, for example: Terminal 1 started preparing to turn or change lanes at a distance of 110 meters from the intersection many times, and Terminal 2 started preparing to turn or change lanes at a distance of 50 meters from the intersection many times.

It can be understood that the detailed description of this disclosure involve the historical driving data of the corresponding terminal of the user. When the above embodiments of this disclosure need to apply the data to a specific product or technology, it is necessary to obtain permission or consent from the user, and the collection, use and processing of relevant data need to be in compliance with relevant laws, regulations and standards of relevant countries and regions.

In some embodiments, after the client obtains the historical driving data of the terminal, it performs lane change analysis on the historical driving data to obtain the lane change analysis result. Lane change analysis refers to analyzing the lane change situation based on the historical driving data, so as to determine the distance threshold range based on the lane change analysis result. For example: lane change analysis is performed based on the historical driving data corresponding to terminal 1 and the distance threshold range correspondingly configured for the terminal 1 is determined as 50 meters; lane change analysis is performed based on the historical driving data corresponding to terminal 2 and the distance threshold range correspondingly configured for the terminal 2 is determined as 110 meters, in some embodiments, Different terminals are correspondingly configured with the same or different distance threshold ranges, which is not limited in the embodiments of this disclosure.

Schematically, the analysis methods for the lane change analysis include at least one of the following methods:
1. Establish a lane change analysis model and input historical driving data into the lane change analysis model for lane change analysis to obtain the lane change analysis result, and use the result as the threshold distance range;
2. perform lane change analysis based on the historical lane change distance in the historical driving data: The weighted sum or weighted average of historical lane change distances is used as the distance threshold range.

Notably, the above-mentioned analysis methods for lane change analysis is only schematic examples, and the specific analysis methods for lane change analysis are not limited in the embodiments of this disclosure.

In some embodiments, after performing lane change analysis on the historical driving data, corresponding lane analysis result is obtained, and the lane analysis result is used for predicting the distance of the terminal for lane change in the navigation route, and the distance of the lane change can also be directly used as the distance threshold range, which is not limited in the embodiments of this disclosure. By determining the distance threshold range based on historical driving data, the distance threshold range can be more suitable for users, and the targeted determination of continuous intersections can be realized, thereby improving the display rationality of road prompt information and further improving driving safety.

Step 4044, in response to the terminal being within the prompt range of the current intersection, providing lane prompt information corresponding to the current intersection and lane prompt information corresponding to subsequent intersections based on the parameters of the display screen.

In some embodiments, the specific method for determining the subsequent intersection based on the parameters of the display screen includes at least one of the following methods:
1. the parameters of the display screen include the size of the display screen. Based on the size of the display screen, the client can provide lane prompt information corresponding to the current intersection and lane prompt information corresponding to a fourth number of subsequent intersections after the current intersection, where the fourth number is in a positive correlation relationship with the size of the terminal display screen;
schematically, when the size of the display screen corresponding to the terminal is five to six inches, the client provides lane prompt information corresponding to the current intersection and the next intersection; when the size of the display screen corresponding to the terminal is six to seven inches, the client provides lane prompt information corresponding to the current intersection and the next two intersections; when the size of the display screen corresponding to the terminal is greater than seven inches, the client provides lane prompt information corresponding to the current intersection and the subsequent three intersections.
2. The client can determine the currently displayed intersections in the navigation route displayed on the current navigation interface based on the size of the display screen, and then provide lane prompt information corresponding to the current intersection and lane prompt information corresponding to the currently displayed intersections after the current intersection. The currently displayed intersection refers to all intersections currently displayed on the display screen except the current intersection. By determining the subsequent intersection based on the parameters of the display screen, the rationality of providing road prompt information can be improved, and it is convenient for the user to obtain the road prompt information, thereby improving the driving experience of the user.

Step 4045, in response to the terminal being within the prompt range of the current intersection, providing lane prompt information corresponding to the current intersection and lane prompt information corresponding to subsequent intersections based on the navigation phase.

That is, the subsequent intersection is determined based on the navigation phase. In some embodiments, Based on the navigation phase of the terminal in the navigation route, the client provides lane prompt information corresponding to the current intersection, and lane prompt information corresponding to the fifth number of subsequent intersections after the current intersection, where there is a corresponding relationship between the fifth number and the navigation phase, and the navigation phase is a phase divided according to preset division rules.

In some embodiments, in the initial stage of driving, the user is relatively unfamiliar with the road, so it is necessary to remind the user of multiple intersections so that the user understands and gets familiar with the road; At the end of driving, the user needs more detailed road guidance and more prompts because he is approaching the destination; on designated road sections, for example: on highway sections, because driving errors usually lead to long-distance wrong route driving, it is necessary to increase intersection prompts so as to avoid missing intersections/route deviation problems.

Schematically, in the first 5 km of driving, the client provides lane prompt information corresponding to the current intersection, and lane prompt information corresponding to the subsequent three intersections of the current intersection; in the last 2 km of driving, the client provides lane prompt information corresponding to the current intersection and lane prompt information corresponding to the subsequent two intersections of the current intersection; on highway sections, the client provides lane prompt information corresponding to the current intersection, and lane prompt information corresponding to the subsequent three intersections of the current intersection; on other road sections, the client provides lane prompt information corresponding to the current intersection and the next intersection.

Step 4046, in response to the terminal being within the prompt range of the current intersection, provide lane prompt information corresponding to the current intersection and lane prompt information corresponding to subsequent intersections based on the traffic flow corresponding to the navigation route.

That is, the subsequent intersections are determined based on traffic flow. In some embodiments, based on the traffic flow information corresponding to the navigation route of the terminal, the client provides lane prompt information corresponding to the current intersection, and lane prompt information corresponding to a sixth number of subsequent intersections after the current intersection, where there is a corresponding relationship between the sixth number and the traffic flow.

During the driving process, when the traffic flow is large, the vehicle travels slowly, and the number of subsequent intersections that need to be displayed is relatively small; when the traffic flow is small, the road is relatively smooth, the vehicle travels relatively fast, and the number of subsequent intersections that need to be displayed is relatively large.

Schematically, when the traffic flow is three vehicles per second, the traffic flow is small, and lane prompt information corresponding to the current intersection and lane prompt information corresponding to the subsequent three intersections of the current intersection can be provided; when the traffic flow is eight vehicles per second, the traffic flow is relatively large, and lane prompt information corresponding to the current intersection and the next intersection can be provided.

It is worth noting that the methods for determining subsequent intersections shown in the above step 4051 to step 4056 are only schematic examples, and the embodiments of this disclosure can also determine subsequent intersections by other methods, for example: according to the number of historical navigation to the same destination, the number of subsequent intersections for which lane prompt information needs to be provided. No definition is made by this disclosure in this regard.

To sum up, in the method provided by the embodiments of this disclosure, when the location of the terminal is within the prompt range of the current intersection and the lane prompt information of the current intersection and the lane prompt information of the subsequent intersection are simultaneously displayed, pre-reminder of the lanes of the current intersection and subsequent intersections during the navigation process is realized so as to indicate to the user the intersection conditions included in the navigation route and the corresponding lane switching requirements, and to reduce the situation where users encounter continuous intersections during driving and are prone to lane-changing errors, thereby reducing the driving detour rate, and improving the accuracy and fineness of the lane indication function so as to ensure the driving safety of users.

The method provided in this embodiment determines the subsequent intersections that need to provide lane prompt information by specifying intersections, so that according to the intersection conditions in the navigation route, the subsequent intersections that meet the specified conditions can be screened out and corresponding lane reminder information can be provided. Thus, the lane prompting are more in line with the intersection conditions in the current navigation route, and the efficiency and accuracy of lane prompting are improved.

In the method provided in this embodiment, by determining the number of subsequent intersections that need to provide lane prompt information according to the driving parameters, it is possible to determine in real time and adjust the number of subsequent intersections that need to provide lane prompt information according to the current driving state (including driving speed and currently used gear) corresponding to the terminal, so that lane prompting are more in line with the driving situation of the vehicle, and the efficiency and accuracy of lane prompting are improved.

The method provided in this embodiment determines the number of subsequent intersections that need to provide lane prompt information by means of the intersection location, so that lane prompting can be performed on at least two adjacent subsequent intersections that meet the distance requirements, and synchronous prompts are performed on intersections whose distance from the current intersection is close or where the distance between two adjacent intersections is close, so that lane prompting are more in line with the continuous situation of the intersections, and the efficiency and accuracy of lane prompting are improved.

The method provided in this embodiment determines the number of subsequent intersections that need to provide lane prompt information in the navigation phase, so that lane prompt information corresponding to different numbers of subsequent intersections can be provided based on different navigation phases during the navigation process. Thus, lane prompting are more in line with the requirements of the navigation process and the efficiency and accuracy of lane prompting are improved.

The method provided in this embodiment determines the number of subsequent intersections that need to provide lane prompt information by means of the traffic flow corresponding to the navigation route, so that the intersection number of subsequent intersections that display lane prompt information is adjusted according to the real-time traffic flow of the current road, and the accuracy and efficiency of providing lane prompt information can be improved, thereby improving navigation efficiency.

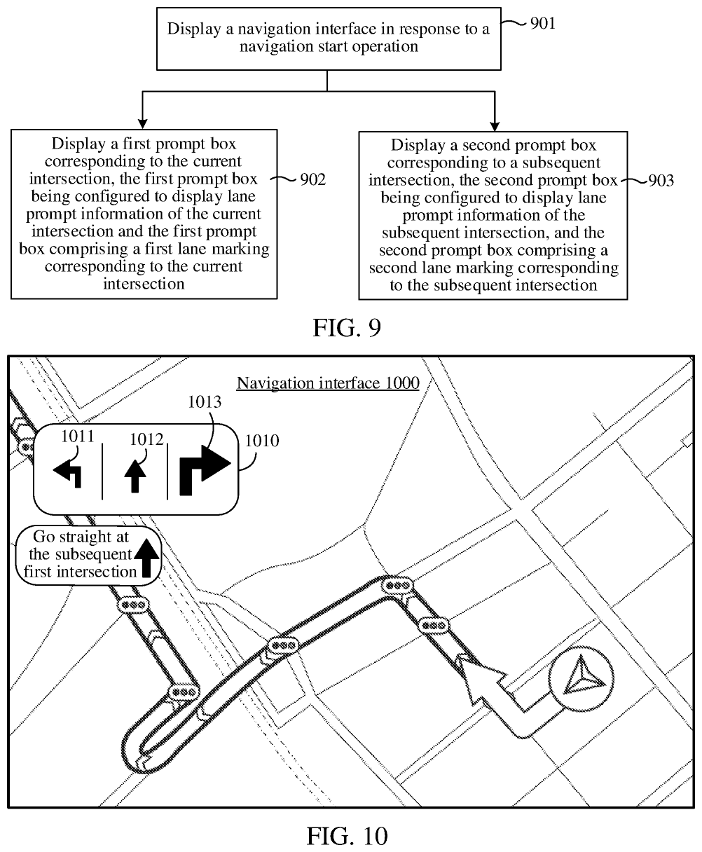

In one embodiment, the above lane prompt information is displayed on the navigation interface in the form of a prompt box. FIG. 9 is a flow chart of a lane indication method provided by another exemplary embodiment of this disclosure, where an example in which the method is applied to the client mounted and operated in the terminal is taken; as shown in FIG. 9, the method includes the following steps:

Step 901: in response to a navigation start operation, displaying a navigation interface.

The navigation start operation indicates performing navigation based on a navigation start position and a navigation end position, the navigation interface is configured to display a navigation route, and the navigation route includes at least one intersection. Step 901 is the same as introduced in the above embodiments. For the content not described in the embodiments of this disclosure, reference may be referred to the above embodiments. No further detail will be provided herein.

Step 902, display a first prompt box corresponding to the current intersection, the first prompt box being configured to display lane prompt information corresponding to the current intersection, the first prompt box includes a first lane marking corresponding to the current intersection.

The first lane marking indicates the lane distribution of the current intersection. In some embodiments, at least one first lane marking corresponding to the current intersection is displayed in the first prompt box, each first lane marking corresponds to a lane of the current intersection, and the first prompt box is also configured to display the specific distribution position corresponding to each lane of the current intersection, for example: Lane a is the second lane on the left, lane b is the first lane on the right, etc.

In some embodiments, In the first prompt box, the client highlights a first target lane marking, the first target lane marking being a marking of the recommended lane corresponding to the navigation route in the first lane marking. The number of the first target lane markings is one or more. Schematically, when there is a need to go straight at the current intersection, and the current intersection only includes a second lane as a straight lane, the first target lane marking is the marking of the second lane; in response to that the second lane and the third lane included in the intersection are both straight lanes, the first target lane marking includes the marking of the second lane and the marking of the third lane.

In some embodiments, the methods for highlighting the first target lane marking include at least one of the following:
1. highlighting the first target lane marking;
schematically, the outer frame of the first target lane marking is highlighted in yellow; or displaying a highlighted yellow background within the frame of the first target lane marking; or the first target lane marking is illuminated and highlighted, which is not limited in the embodiments. For example, first lane markings other than the first target lane marking are displayed in a regular color, for example: black.
2. flashing and displaying the first target lane marking;
schematically, the first target lane marking is flashed and displayed at a preset frequency cycle, for example: the first target lane marking is flashed and displayed at a frequency of flashing once per second.
3. zooming in to display the first target lane marking;
schematically, the first target lane marking is displayed in a first size, and other first lane markings other than the first target lane marking are displayed in a second size, where the first size is larger than the second size.

As shown in FIG. 10, a first prompt box 1010 is displayed on the navigation interface 1000, and there are three lanes displayed in the first prompt box 1010, which are respectively a left-turn lane 1011, a straight lane 1012 and a right-turn lane 1013. There is a need to turn right at the current intersection, and thus the client zooms in and displays the logo of the right-turn lane 1013.
4. Display the first target lane marking in a text mode;

Schematically, the client may display the text content “Turn left at the current intersection, please take the first lane on the left” in the first prompt box, where “the first lane on the left” is a first target lane marking.

Adjust the first target lane marking from a first color to a second color.

The first color is a display color in a default display state.

That is, the client displays other first lane markings except the first target lane marking in the first color, and displays the first target lane marking in a second color, where the first color and the second color are different. In some embodiments, the second color is more striking than the first color, for example: the second color is red, and the first color is gray.

In some embodiments, the first prompt box may include at least one of a bubble prompt box, a window prompt box, an animation prompt box, and a message pop-up box.

The bubble prompt box displays lane prompt information on the navigation interface in the form of a bubble box. Schematically, the bubble prompt box can be implemented as a bubble box correspondingly displayed when a message is sent in social software. In some embodiments, the bubble prompt box includes an indication tail, and the indication tail indicates the intersection of the lane prompt information corresponding to the navigation route and indicated by the bubble prompt box in the navigation interface. Schematically, as shown in FIG. 11, a bubble prompt box 1110 is displayed in a navigation interface 1100, and an indication tail 1111 of a bubble prompt box 1110 correspondingly points to an intersection 1112, so as to indicate that the lane prompt information in the bubble prompt box is related to the intersection. In some embodiments, when the intersection corresponding to the bubble prompt box is displayed on the navigation interface, the indication tail of the bubble prompt box is pointed to the intersection; when the intersection corresponding to the bubble prompt box is not displayed on the navigation interface, the bubble prompt box is displayed at a specified preset position and the indication tail is displayed in a preset direction, or the indication tail is not displayed.

The window prompt box displays lane prompt information on the navigation interface in the form of a pop-up window. Schematically, the pop-up window can be implemented as a pop-up window displayed from the location of the corresponding intersection, so as to indicate the intersection corresponding to the lane prompt information in the window prompt box.

The animation prompt box displays lane prompt information on the navigation interface in the form of animation. Schematically, the animation prompt box can be implemented as a marquee animation, and when the animation prompt box is implemented as a marquee animation, lane prompt information is displayed within the range of the marquee animation frame; alternatively, the animation prompt box can be implemented as an animation character. When the animation prompt box is implemented as an animation character, lane prompt information is displayed around the animation character as the expression information of the animation character.

The message pop-up box displays lane prompt information on the navigation interface in the form of a push message. Schematically, the client may pop up a first push message on the top of the navigation interface, and the message content of the first push message includes “Turn left at the current intersection, and please take the first lane on the left”.

Step 903, display a second prompt box corresponding to the subsequent intersection, the second prompt box being configured to display lane prompt information of the subsequent intersection, and the second prompt box including a second lane marking corresponding to the subsequent intersection.

The second lane marking indicates the lane distribution of the subsequent intersection. In some embodiments, the first prompt box and the second prompt box are displayed synchronously, or after the first prompt box is displayed for a preset duration, the second prompt box starts to be displayed, for example: after the first prompt box starts to be displayed for one second, the second prompt box starts to be displayed.

In some embodiments, the display shape, color, and size of the first prompt box are the same as or different from the display shape, color, and size of the second prompt box, which is not limited in the embodiments of this disclosure.

At least one second lane marking corresponding to the subsequent intersection is displayed in the second prompt box, each second lane marking corresponds to a lane of the subsequent intersection, and the second prompt box is also configured to display the specific distribution position corresponding to each lane, for example: Lane c is the second lane on the left, lane d is the first lane on the right, etc.

In some embodiments, In the second prompt box, the client highlights the second target lane marking, where the second target lane marking is a marking of the recommended lane corresponding to the navigation route in the second lane marking. The number of second target lane markings is one or more. Schematically, when there is a need to go straight at the next intersection and the next intersection only includes one second lane as a straight lane, the second target lane marking is the marking of the second lane; when both the second lane and the third lane included in the next intersection are straight lanes, the second target lane markings include the marking of the second lane and the marking of the third lane.

In some embodiments, the method for highlighting the second target lane marking includes at least one of the following methods:
1. highlighting the second target lane marking;
2. flashing and displaying the second target lane marking;
3. zooming in and displaying the second target lane marking;
4. displaying the second target lane marking in the form of text;
5. adjusting the second target lane marking from a first color to a second color.

For the method for highlighting the second target lane marking, reference may be made to the method for highlighting the first target lane marking. No further details will be provided herein. Notably, the method for highlighting the first target lane marking is the same as or different from the method for highlighting the second target lane marking.

In some embodiments, the second prompt box includes at least one of a bubble prompt box, a window prompt box, an animation prompt box, and a message pop-up box.

In some embodiments, in response to the fact that the subsequent intersection is the next intersection of the current intersection, the client displays the second prompt box at a preset location around the first prompt box; alternatively, in response to the fact that the subsequent intersection includes at least two intersections after the current intersection, the second prompt boxes respectively corresponding to at least two intersections at preset locations around the first prompt box are displayed subsequently.

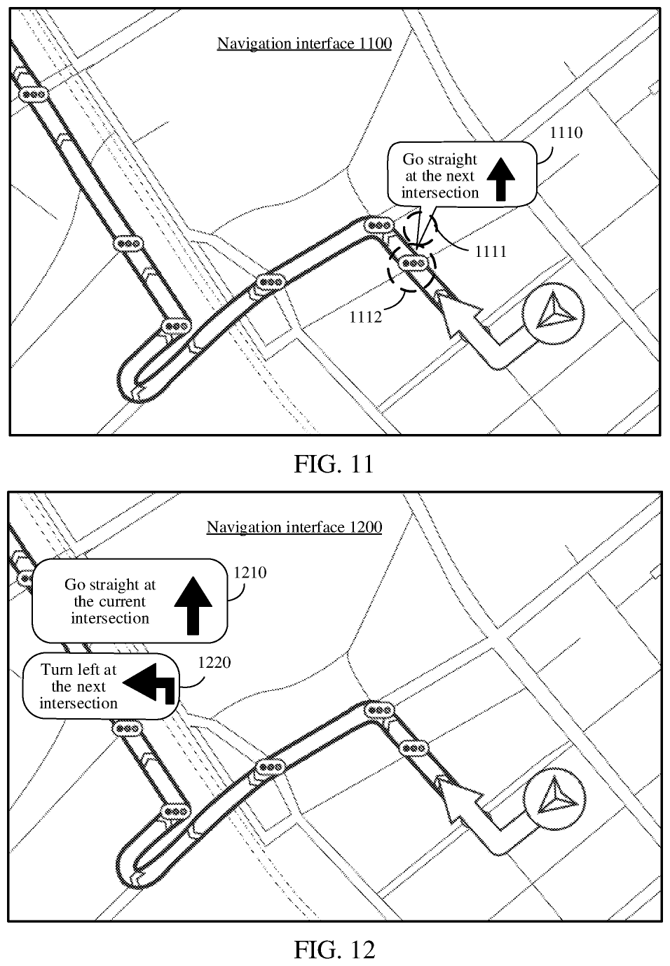

Schematically, when the subsequent intersection is the next intersection of the current intersection, the client connects the first prompt box below the first prompt box and displays the second prompt box. In some embodiments, the display size of the second prompt box is smaller than the display size of the first prompt box. Illustratively, as shown in FIG. 12, a first prompt box 1210 and a second prompt box 1220 are displayed on the navigation interface 1200, where the display size of the second prompt box 1220 is smaller than the display size of the first prompt box 1210.

When the subsequent intersection includes at least two intersections after the current intersection, the client connects the first prompt box below the first prompt box and sequentially displays the second prompt boxes corresponding to at least two intersections, and the second prompt boxes are displayed in a connected manner.

In some embodiments, the method for displaying the second prompt boxes corresponding to at least two subsequent intersections includes at least one of the following:
1. when the subsequent intersection includes at least two intersections after the current intersection, the display sizes of the second prompt boxes corresponding to the at least two intersections are the same, and the display size of the second prompt box is smaller than that of the first prompt box;

That is, at a preset location around the first prompt box, a plurality of second prompt boxes are displayed, each of the second prompt boxes is displayed with the same size, and the size of the first prompt box is larger than that of the second prompt frame.

In some embodiments, the plurality of second prompt boxes are arranged and displayed in parallel horizontally or vertically. Taking a plurality of second prompt boxes vertically arranged and displayed as an example, as shown in FIG. 13, the navigation interface 1300 includes a first prompt box 1310 and two second prompt boxes, where the second prompt box includes a prompt box 1320 corresponding to the subsequent first intersection, and a prompt box 1330 corresponding to the subsequent second intersection; Where the display size of the prompt box 1320 corresponding to the subsequent first intersection is consistent with the display size of the prompt box 1330 corresponding to the subsequent second intersection, and the display size of the first prompt box 1310 is larger than that of the prompt box 1320 and that of the prompt box 1330.
2. When the subsequent intersections include at least two intersections after the current intersection, the display sizes of the second prompt boxes corresponding to the at least two intersections are sequentially reduced along with the arrangement order of the at least two intersections;

That is, a plurality of second prompt boxes are displayed at a preset location around the first prompt box, and the display size of each of the second prompt boxes gradually decreases according to the arrangement order of the intersections.

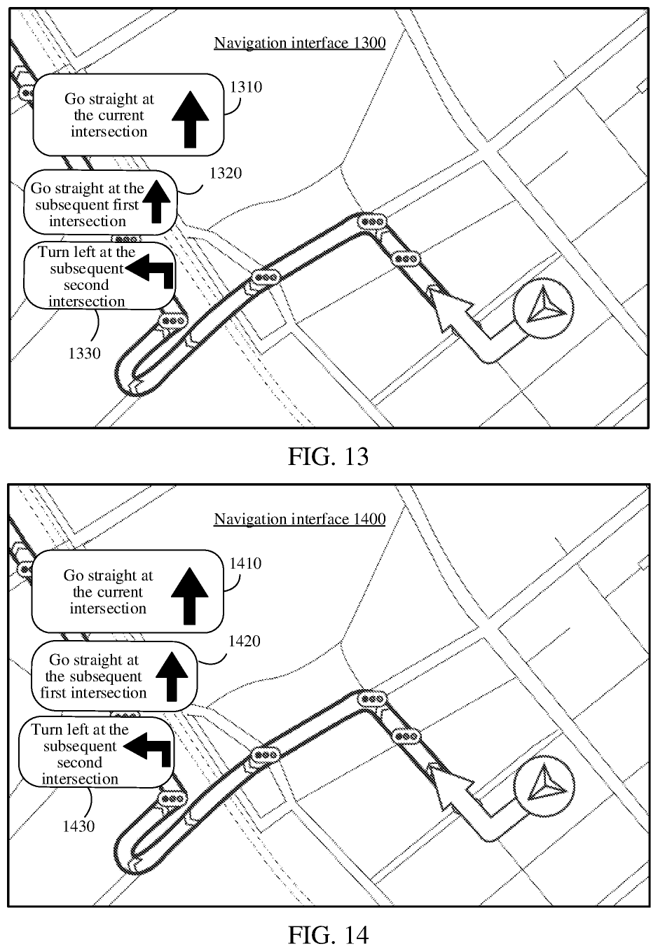

Schematically, as shown in FIG. 14, the navigation interface 1400 includes a first prompt box 1410 and two second prompt boxes, where the second prompt box includes a prompt box 1420 corresponding to the subsequent first intersection, and a prompt box 1430 corresponding to the subsequent second intersection; where the display size of the prompt box 1420 is larger than the display size of the prompt box 1430, and the display size of the first prompt box 1410 is larger than the display size of the prompt box 1420.

In some embodiments, after the terminal passes the current intersection, the client takes the next intersection of the original current intersection as the current intersection, and adjusts the display sizes of a plurality of second prompt boxes correspondingly. Schematically, the display size of the second prompt box corresponding to the original next intersection is adjusted to the display size of the original first prompt box, and the display size of the second prompt box corresponding to the original subsequent w^{th} intersection is adjusted to the display size of the second prompt box corresponding to the original subsequent (w−1)^{th} intersection, w being a positive integer.
3. When the subsequent intersections includes n intersections after the current intersection, the second prompt boxes corresponding to the first i subsequent intersections after the current intersection are displayed as the first size, and the second prompt boxes corresponding to the (i+1)^{th} to n^{th} subsequent intersections are displayed as the second size, where the first size is smaller than the display size of the first prompt box, the second size is smaller than the first size, n≥2, i is a positive integer, and i≤n.

That is, the first prompt box corresponding to the current intersection, the second prompt boxes corresponding to the specified number of subsequent intersections, and the second prompt boxes after the specified number are displayed in different display sizes.

Schematically, taking the value of i above as 2 and the value of n as 3 as an example for illustration, a first prompt box is correspondingly displayed at the current intersection, the second prompt boxes corresponding to the two subsequent intersections after the current intersection are displayed as the first size, and the second prompt box corresponding to the subsequent third intersection is displayed as the second size.

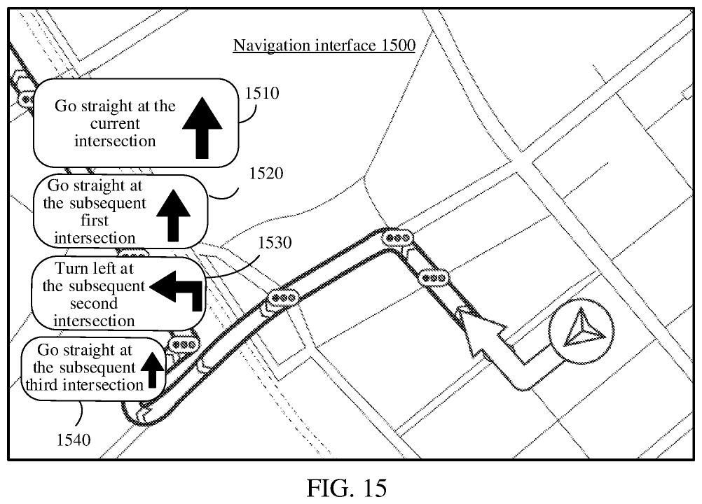

Schematically, as shown in FIG. 15, the navigation interface 1500 includes a first prompt box 1510 and three second prompt boxes, where the second prompt box includes a prompt box 1520 corresponding to the subsequent first intersection, a prompt box 1530 corresponding to the subsequent second intersection, and a prompt box 1540 corresponding to the subsequent third intersection; where the display size of the prompt box 1540 is smaller than the display sizes of the prompt box 1530 and the prompt box 1520, the display size of the prompt box 1530 is consistent with the display size of the prompt box 1520, and the display size of the first prompt box 1410 is larger than the display sizes of the prompt box 1530 and the prompt box 1520.

In some embodiments, in addition to indicating the lane prompt information in the form of a prompt box, the lane prompt information may also be indicated in a voice manner. Schematically, in response to the terminal being within the prompt range of the current intersection, the client plays voice prompt information, the voice prompt information including the voice prompt information corresponding to the current intersection and the voice prompt information corresponding to subsequent intersections of the current intersection. The voice prompt information is used for lane prompting, for example, for indicating the driving lane pointing information corresponding to the intersection. Schematically, in response to the terminal being within the prompt range of the current intersection, the client plays the following voice content: “Please go straight at the current intersection, and please take the two lanes in the middle; Please go straight at the next intersection, and please take the two lanes in the middle.”

To sum up, in the method provided by the embodiments of this disclosure, when the location of the terminal is within the prompt range of the current intersection and the lane prompt information of the current intersection and the lane prompt information of the subsequent intersection are simultaneously displayed, pre-reminder of the lanes of the current intersection and subsequent intersections during the navigation process is realized so as to indicate to the user the intersection conditions included in the navigation route and the corresponding lane switching requirements, and to reduce the situation where users encounter continuous intersections during driving and are prone to lane-changing errors, thereby reducing the driving detour rate, and improving the accuracy and fineness of the lane indication function so as to ensure the driving safety of users.

The method provided in this embodiment displays the first prompt box corresponding to the current intersection and the second prompt box corresponding to the subsequent intersection, and highlights the first target lane marking in the first prompt box and the second target lane marking in the second prompt box, making it convenient for users to clearly and quickly grasp the intersection information and recommended lanes corresponding to the current intersection and subsequent intersections, thereby improving navigation efficiency and driving safety.

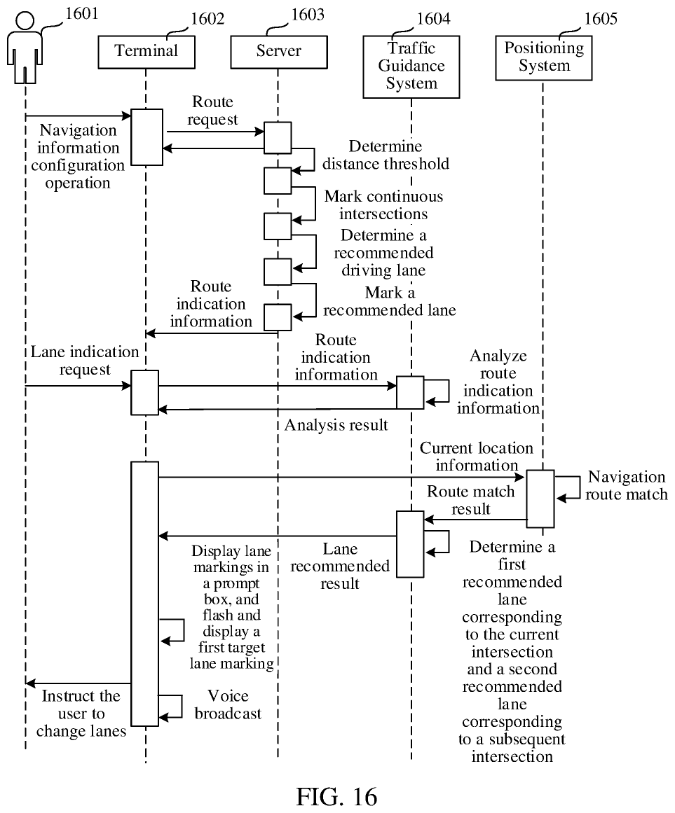

In one embodiment, FIG. 16 shows a schematic diagram of a lane indication method provided in another exemplary embodiment of this disclosure.

As shown in FIG. 16, in response to the user 1601 performing navigation information configuration operation on the user interface of the terminal 1602, the terminal 1602 generates a route request according to the navigation information configuration operation, where the route request includes the historical driving data recorded and stored by the terminal 1602.

The terminal 1602 sends to the server 1603 the configuration parameters (such as navigation start position/navigation end position) corresponding to the historical driving data and navigation information configuration as a route request, the server 1603 performs lane change analysis on the historical driving data contained in the route request to determine the distance threshold range and generate a corresponding navigation route based on the navigation start position and navigation end position contained in the navigation information configuration request, the server 1603 then marks the continuous intersections in the navigation route based on the distance threshold range, and determines the corresponding recommended driving lane in each intersection based on the navigation route.

The server 1603 sends to the terminal 1602 the marked continuous intersections and recommended driving lanes, the terminal 1602 displays a navigation interface, the navigation interface includes route indication information, the route indication information includes a navigation route, and the navigation route includes continuous intersections and recommended lanes at the intersections; when the terminal 1602 receives a lane indication request from the user 1601, the terminal 1602 sends the route indication information to a traffic guidance system 1604.

The traffic guidance system 1604 receives the route indication information and analyzes the same, and feeds back the analysis result to the terminal 1602. At the same time, the positioning system 1605 acquires the current location information of the terminal 1602, and matches the current location of the terminal 1602 with the navigation route to determine the route matching result between the current location of the terminal 1602 and the navigation route and send it to the traffic guidance system 1604. When the current location of the terminal 1602 is within the prompt range of the current intersection in the navigation route, and the distance between the current intersection and the subsequent intersection is smaller than the distance threshold, the traffic guidance system 1604 determines the first recommended lane corresponding to the current intersection and the second recommended lane corresponding to the subsequent intersection, and sends them to the terminal 1602 as the lane recommendation result.

After receiving the lane recommendation result, the terminal 1602 displays the first prompt box corresponding to the current intersection on the navigation interface. The first prompt box displays the first lane marking, and flashes and displays the first target lane marking corresponding to the first recommended lane, and synchronously displays the second prompt box corresponding to the subsequent intersection, the second prompt box displays the second lane marking. At the same time, the first recommended lane and the second recommended lane, as well as the lane information corresponding to the current intersection and the subsequent intersection are broadcast in the form of voice broadcast so as to indicate the user 1601 to change lanes according to the corresponding recommended lanes in the navigation route, thereby improve the accuracy in crossing intersections.

To sum up, the embodiments of this disclosure provide a lane indication method, when the location of the terminal is within the prompt range of the current intersection and the lane prompt information of the current intersection and the lane prompt information of the subsequent intersection are simultaneously displayed, pre-remind of the lanes of the current intersection and subsequent intersections during the navigation process is realized, in order to indicate to the user the intersection conditions included in the navigation route and the corresponding lane switching requirements, and to reduce the situation where users encounter continuous intersections during driving and are prone to lane-changing errors, thereby reduce the driving detour rate, and improving the accuracy and fineness of the lane indication function so as to ensure the driving safety of users.

In the embodiments of this disclosure, standard data is used to instruct the user to drive to the recommended lane by means of a pre-recommended lane in the case of non-lane-level positioning, so as to realize lane change in advance, thereby reducing yawing resulting from the failure to change lanes because of short distances and guiding users to reach their destinations safely, thereby improving the success rate and safety of driving.

During the navigation process, due to the road design, there is a need to complete multiple lane changes within a relatively short distance, and in special cases, and there is a need to change lanes to the correct lane in time after changing the direction so as to drive along the correct route. In view of the above situations, the technical solution proposed by the embodiments of this disclosure indicate in advance, during the navigation process, the recommended lane corresponding to the first intersection ahead and the correct lane information corresponding to the second intersection after turning, helping the user to understand the upcoming lane change in advance, so as to guide user to drive along the best lane, thus helping the user to change lanes to the correct lane in time, enabling the user to drive safely and correctly to the destination, and further improving the success rate and safety of driving.

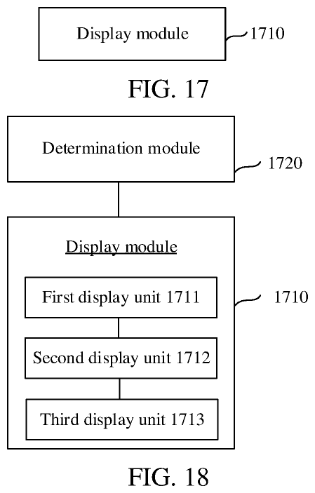

FIG. 17 is structural block diagram of a lane indication apparatus provided by an exemplary embodiment of this disclosure. As shown in FIG. 17, the apparatus includes:
a display module 1710 configured to display a navigation interface in response to a navigation start operation, where the navigation start operation indicates performing navigation based on a navigation start position and a navigation end position, the navigation interface is configured to display a navigation route, and the navigation route includes at least one intersection;
the display module 1710 is also used for providing lane prompt information corresponding to the current intersection, and lane prompt information corresponding to the subsequent intersection of the current intersection in response to being within the prompt range of the current intersection, where the lane prompt information is used for lane prompting.

In one embodiment, as shown in FIG. 18, the apparatus further includes: a determination module 1720.

The determination module 1720 is used for determining a first presentation mode of the lane prompt information corresponding to the current intersection, the first presentation mode including at least one of information types and presentation forms of the lane prompt information corresponding to the current intersection;
the determination module 1720 is also used for determining a second presentation mode of the lane prompt information corresponding to the subsequent intersection, the second presentation mode including at least one of information types and presentation forms of the lane prompt information corresponding to the subsequent intersection; where the lane prompt information corresponding to the current intersection is displayed in the first presentation mode and the lane prompt information of the subsequent intersections is displayed in the second presentation mode.

In one embodiment, the information types include at least one of the following: lane pointing information, recommended lane information, a distance between an intersection and a designated location, lane traffic conditions and speed limit requirements; where the lane pointing information refers to lane distribution information corresponding to the intersection, and the recommended lane information indicates a recommended lane corresponding to an intersection in the navigation route.

In one embodiment, the determination module 1720 is also used for determining, based on the intersection display strategy, the subsequent intersection of the lane after determining the subsequent intersections where the lane prompt information needs to be displayed after the current intersection; Where the intersection display strategy is related to at least one of intersection distribution in the navigation route, dynamic parameters of the driving process, and static parameters of the driving process, the dynamic parameters being parameters updated in real time according to the driving process and the static parameters being parameters that remain unchanged during the driving process.

In one embodiment, the subsequent intersection is a designated intersection after the current intersection; or the subsequent intersections are determined based on driving parameters; or the subsequent intersections are determined based on an intersection positional relationship; or the subsequent intersections are determined based on parameters of the display screen; or the subsequent intersections are determined based on a navigation phase; or the subsequent intersections are determined based on traffic flow corresponding to the navigation route.

In one embodiment, the subsequent intersection is a designated intersection after the current intersection;
the display module 1710 is also used for providing lane prompt information corresponding to the current intersection and lane prompt information corresponding to the next intersection of the current intersection; or providing lane prompt information corresponding to the current intersection and lane prompt information corresponding to at least two intersections after the current intersection; or providing lane prompt information corresponding to the current intersection and lane prompt information corresponding to an intersection meeting specified conditions after the current intersection.

In one embodiment, the subsequent intersection is determined based on the driving parameters, and the driving parameters include driving speed;
the display module 1710 is also used for providing lane prompt information corresponding to the current intersection and lane prompt information corresponding to a first number of subsequent intersections after the current intersection based on the driving speed, where the first number is in a positive correlation relationship with the driving speed.

In one embodiment, the subsequent intersection is determined based on the driving parameters, the driving parameters including gear parameters;
the display module 1710 is also used for providing lane prompt information corresponding to the current intersection and lane prompt information corresponding to a second number of subsequent intersections after the current intersection based on the driving gear, where there is a corresponding relationship between the driving gear and the second number.

In one embodiment, the subsequent intersections are determined based on the intersection positional relationship;

The display module 1710 is also used for providing lane prompt information corresponding to the current intersection and lane prompt information corresponding to a third number of subsequent intersections based on the distance between the current intersection and the subsequent intersections, where the third number is determined based on the distance between the current intersection and the subsequent intersections.

In one embodiment, the display module 1710 is also used for determining subsequent intersections whose distances from the current intersection meet the first distance requirement, providing lane prompt information corresponding to the current intersection, and lane prompt information corresponding to the third number of subsequent intersections meeting the first distance requirement; or determining, among the current intersection and the subsequent intersections, the subsequent intersections where the distance between two adjacent intersections meets the second distance requirement, providing lane prompt information corresponding to the current intersection, and lane prompt information corresponding to the third number of subsequent intersections meeting the second distance requirement.

In one embodiment, the first distance requirement or the second distance requirement includes a preset distance threshold range; or the first distance requirement or the second distance requirement includes a distance threshold range determined according to historical driving data of the terminal.

In one embodiment, the subsequent intersections are determined based on the parameters of the display screen, the parameters of the display screen including the size of the display screen;
the display module 1710 is also used for providing lane prompt information corresponding to the current intersection and lane prompt information corresponding to a fourth number of subsequent intersections after the current intersection based on the size of the display screen, where the fourth number is in a positive correlation relationship with the display screen.

In one embodiment, the subsequent intersections are determined based on the navigation phase;

The display module 1710 is also used for providing lane prompt information corresponding to the current intersection and lane prompt information corresponding to a fifth number of subsequent intersections after the current intersection based on the navigation phase, where the fifth there is a corresponding relationship between the fifth number and the navigation phase, and the navigation phase is a phase divided according to preset division rules.

In one embodiment, as shown in FIG. 18, the display module 1710 further includes: a first display unit 1711 and a second display unit 1712.

The first display unit 1711 is configured to display the first prompt box corresponding to the current intersection, the first prompt box is configured to display lane prompt information of the current intersection, and the first prompt box includes a first lane marking corresponding to the current intersection, and the first lane marking indicates the lane distribution of the current intersection;
the second display unit 1712 is configured to display the second prompt box corresponding to the subsequent intersection, the second prompt box is configured to display lane prompt information of the subsequent intersection, and the second prompt box includes a second lane marking corresponding to the subsequent intersection, and the second lane marking indicates the lane distribution of the current intersection.

In one embodiment, the second display unit 1712 is also configured to display the second prompt box at a preset location around the first prompt box in response to the subsequent intersection being the next intersection of the current intersection; or in response to the subsequent intersections including at least two intersections after the current intersection, sequentially arranging and displaying the second prompt boxes respectively corresponding to the at least two intersections at the preset location around the first prompt box.

In one embodiment, when the subsequent intersection is the next intersection of the current intersection, the display size of the second prompt box is smaller than the display size of the first prompt box.

In one embodiment, when the subsequent intersection includes at least two intersections after the current intersection, the second prompt boxes respectively corresponding to the at least two intersections have the same display size, and the display sizes of the second prompt boxes are smaller than the display size of the first prompt box; or when the subsequent intersection includes at least two intersections after the current intersection, the display sizes of the second prompt boxes respectively corresponding to the at least two intersections gradually decrease with the arrangement order of the at least two intersections; or when the subsequent intersections include n intersections after the current intersection, the second prompt boxes corresponding to the first i subsequent intersections after the current intersection are displayed as a first size, the second prompt boxes corresponding to the (i+1)^{th} to n^{th} subsequent intersections are displayed as a second size, where the first size is smaller than the display size of the first prompt box, the second size is smaller than the first size, n≥2, i is a positive integer, and i≤n.

In one embodiment, as shown in FIG. 18, the display module 1710 further includes: a third display unit 1713.

The third display unit 1713 is used for highlighting the first target lane marking in the first prompt box, the first target lane marking being a marking of a recommended lane corresponding to the navigation route in the first lane marking.

In one embodiment, the third display unit 1713 is also used for highlighting a second target lane marking in the second prompt box, the second target lane marking being a marking of a recommended lane corresponding to the navigation route in the second lane marking.

To sum up, the embodiments of this disclosure provide a lane indication apparatus; when the location of the terminal is within the prompt range of the current intersection, and the lane prompt information of the current intersection and the lane prompt information of the subsequent intersections are simultaneously displayed, pre-reminder of the lanes of the current intersection and subsequent intersections during the navigation process is realized in order to indicate to the user the intersection conditions included in the navigation route and the corresponding lane switching requirements, and to reduce the occurrence where users encounter continuous intersections during driving and are prone to lane-changing errors, thereby reducing the driving detour rate, and improving the accuracy and fineness of the lane indication function, so as to ensure the driving safety of users.

Notably: For the lane indication apparatus provided by the above embodiments, only the division of the above function modules is exemplified for illustration. In practical application, the above functions may be allocated to and completed by different function modules according to requirements, that is, the internal structure of the device is divided into different function modules so as to complete all or part of the functions described above. In addition, the lane indication apparatus and lane indication method provided by the above embodiments belong to the same concept. For the specific implementation process of the apparatus and the method, please refer to the method embodiments. No further will be given herein again.

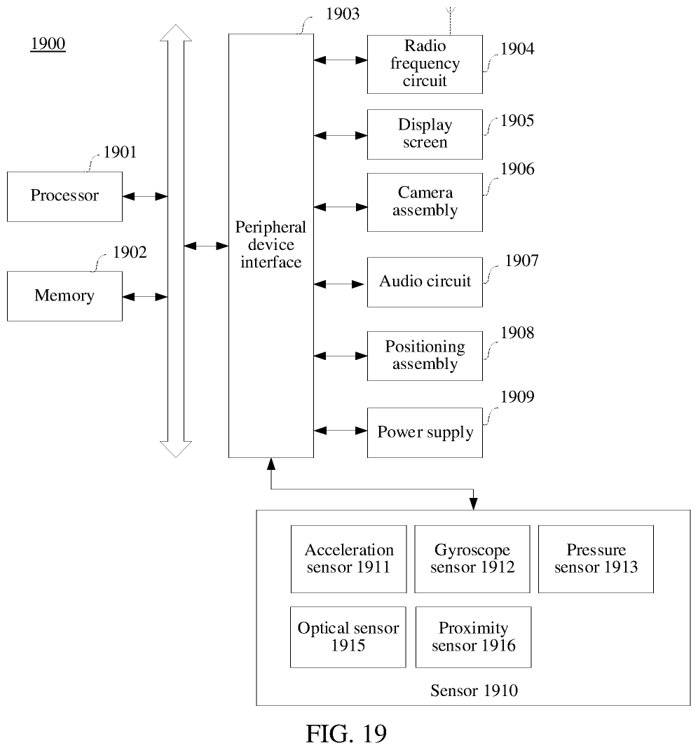

FIG. 19 shows a structural block diagram of a computer device 1900 provided by an exemplary embodiment of this disclosure. The computer device 1900 may be a portable mobile terminal, for example: a smartphone, an in-vehicle terminal, a tablet PC, an MP3 (Moving Picture Experts Group Audio Layer III) player, an MP4 (moving picture experts group audio layer IV) player, a laptop or a desktop computer. The computer device 1900 may also be called a terminal device, a user equipment, a portable terminal, a laptop terminal, a desktop terminal, or the like.

Typically, the computer device 1900 includes: a processor 1901 and a memory 1902.

The processor 1901 may include one or more processing cores, for example, a 4-core processor, an 8-core processor, or the like. The processor 1901 may be implemented in at least one hardware form of a digital signal processor (DSP), a field-programmable gate array (FPGA), and a programmable logic array (PLA). The processor 1901 may also include a main processor and a co-processor. The main processor is a processor for processing data in a wake-up state, also called a CPU (Central Processing Unit); The co-processor is a low-power processor for processing data in a standby state. In some embodiments, the processor 1901 may be integrated with a graphics processing unit (GPU). The GPU is used for rendering and drawing content that needs to be displayed on the display screen. In some embodiments, the processor 1901 may further include an artificial intelligence (AI) processor. The AI processor is used for processing computing operations related to machine learning.

The memory 1902 may include one or more computer-readable storage media. The computer-readable storage medium may be non-transient. The memory 1902 may further include a high-speed random access memory and a nonvolatile memory, for example, one or more disk storage devices or flash storage devices. In some embodiments, the non-transitory computer-readable storage medium in the memory 1902 is used for storing a computer program, the computer program being executed by the processor 1901 so as to implement the above lane indication method.

In an embodiment, the computer device 1900 may further include: a peripheral device interface 1903 and at least one peripheral device. The processor 1901, the memory 1902, and the peripheral device interface 1903 may be connected by means of a bus or a signal line. Each peripheral device may be connected to the peripheral device interface 1903 by means of a bus, a signal line, or a circuit board. Specifically, the peripheral device includes: at least one of a radio frequency circuit 1904, a display screen 1905, a camera assembly 1906, an audio circuit 1907, a positioning assembly 1908 and a power supply 1909.

The peripheral device interface 1903 may be configured to connect the at least one peripheral related to input/output (I/O) to the processor 1901 and the memory 1902. In some embodiments, the processor 1901, the memory 1902 and the peripheral device interface 1903 are integrated on the same chip or circuit board; In some other embodiments, any one or two of the processor 1901, the memory 1902 and the peripheral device interface 1903 may be implemented on a separate chip or circuit board, which is not limited in the embodiments.

The RF (Radio Frequency) circuit 1904 is used for receiving and transmitting a RF signal, also referred to as an electromagnetic signal. The RF circuit 1904 communicates with a communication network and other communication devices by means of the electromagnetic signal. The RF circuit 1904 converts an electric signal into an electromagnetic signal for transmission, or converts the electromagnetic signal received into an electric signal. In some embodiments, the radio frequency circuit 1904 includes: an antenna system, an RF transceiver, one or more amplifiers, a tuner, an oscillator, a digital signal processor, a codec chip set, a subscriber identity module card, and the like. The RF circuit 1904 may communicate with other terminals by means of at least one wireless communication protocol. The wireless communication protocol includes but is not limited to: World Wide Web, Metropolitan Area Network, Intranet, mobile communication networks of all generations (2G, 3G, 4G and 5G), wireless local area network and/or WiFi (Wireless Fidelity) network. In some embodiments, the RF circuit 1904 may further include a circuit related to NFC (Near Field Communication). No definition is made in this disclosure in this regard.

The display screen 1905 is configured to display a user interface (UI). The UI may include a graph, a text, an icon, a video, and any combination thereof. When the display screen 1905 is a touch display screen, the display screen 1905 further has the ability to acquire a touch signal on or above a surface of the display screen 1905. The touch signal may be inputted to the processor 1901 as a control signal for processing. In this case, the display screen 1905 may also be used for providing a virtual button and/or a virtual keyboard, also referred to as a soft button and/or a soft keyboard. In some embodiments, the display screen 1905 may be one and is provided on the front panel of the computer device 1900; In some other embodiments, there may be at least two display screens 1905, which are respectively provided on different surfaces of the computer device 1900 or in a folding design; In some other embodiments, the display screen 1905 may be a flexible display screen provided on a curved surface or a folded surface of the computer device 1900. Even, the display screen 1905 may be further configured in a non-rectangular irregular pattern, namely, a special-shaped screen. The display screen 1905 may be prepared by using materials such as a liquid crystal display (LCD), an organic light-emitting diode (OLED), or the like.

The camera component 1906 is configured to capture images or videos. In some embodiments, the camera component 1906 includes a front-facing camera and a rear-facing camera. Generally, the front camera is provided on the front panel of the terminal, and the rear camera is provided on the back surface of the terminal. In some embodiments, there are at least two rear cameras, which are respectively any of a main camera, a depth-of-field camera, a wide-angle camera, and a telephoto camera so as to achieve background blur function by means of fusion of the main camera and the depth-of-field camera, and panoramic photographing and virtual reality (VR) photographing by means of fusion of the main camera and the wide-angle camera, or other fusion photographing functions. In some embodiments, the camera component 1906 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 1907 may include a microphone and a speaker. The microphone is used for acquiring sound waves of a user and an environment, and converting the sound waves into an electrical signal to be inputted to the processor 1901 for processing, or to be inputted to the radio frequency circuit 1904 for implementing voice communication. For the purpose of stereo acquisition or noise reduction, there may be a plurality of microphones, which are respectively provided at different portions of the computer device 1900. The microphone may further be an array microphone or an omni-directional acquisition type microphone. The speaker is used for converting electric signals from the processor 1901 or the RF circuit 1904 into sound waves. The speaker may be a film speaker, or may be a piezoelectric ceramic speaker. When the speaker is the piezoelectric ceramic speaker, the speaker not only can convert electric signals into acoustic waves audible to a human being, but also can convert electric signals into acoustic waves inaudible to a human being, for ranging and other purposes. In some embodiments, the audio circuit 1907 may further include an earphone jack.

The positioning component 1908 is used for positioning the current geographic location of the computer device 1900 so as to implement navigation or location based service (LBS). The positioning component 1908 may be a positioning component based on the global positioning system (GPS) of the United States, the BeiDou System of China, and the GALILEO System of Russia.

The power supply 1909 is used for supplying power to components in the computer device 1900. The power supply 1909 may be an alternating current, a direct current, a primary battery, or a rechargeable battery. When the power supply 1909 includes a rechargeable battery, the rechargeable battery may be a wired rechargeable battery or a wireless rechargeable battery. The wired rechargeable battery is a battery charged by means of a wired circuit, and the wireless rechargeable battery is a battery charged by means of a wireless coil. The rechargeable battery may be further used for supporting fast charging technology.

In some embodiments, the computer device 1900 further includes one or more sensors 1910. The one or more sensors 1910 include but are not limited to: an acceleration sensor 1911, a gyroscope sensor 1912, a pressure sensor 1913, an optical sensor 1914, and a proximity sensor 1915.

The acceleration sensor 1911 can detect the acceleration on the three coordinate axes of the coordinate system established by the computer device 1900. For example, the acceleration sensor 1911 may be used for detecting components of gravity acceleration on the three coordinate axes. The processor 1901 may control, according to a gravity acceleration signal acquired by the acceleration sensor 1911, the touch display screen 1905 to display the user interface in a landscape view or a portrait view. The acceleration sensor 1911 may also be used for acquiring motion data of a game or a user.

The gyroscope sensor 1912 may detect a body direction and a rotation angle of the computer device 1900. The gyroscope sensor 1912 may cooperate with the acceleration sensor 1911 to acquire a 3D action by the user on the computer device 1900. The processor 1901 may implement the following functions according to the data acquired by the gyroscope sensor 1912: motion sensing (such as changing the UI based on the tilt of the user), image stabilization while shooting, game control, and inertial navigation.

The pressure sensor 1913 may be provided on a side edge frame of the computer device 1900 and/or a lower layer of the display screen 1905. When the pressure sensor 1913 is provided on the side edge frame of the computer device 1900, it can detect the grip signal of the user on the computer device 1900, and the processor 1901 performs left and right hand recognition or shortcut operation according to the grip signal acquired by the pressure sensor 1913. When the pressure sensor 1913 is provided on the low layer of the touch display screen 1905, the processor 1901 controls, according to a pressure operation of the user on the display screen 1905, an operable control on the UI. The operable control includes at least one of: a button control, a scroll-bar control, an icon control, or a menu control.

The optical sensor 1914 is used for acquiring ambient light intensity. In an embodiment, the processor 1901 may control the display brightness of the touch display screen 1905 according to the ambient light intensity acquired by the optical sensor 1915. Specifically, when the ambient light intensity is relatively high, the display brightness of the display screen 1905 is increased; and when the ambient light intensity is relatively low, the display brightness of the display screen 1905 is decreased. In another embodiment, the processor 1901 may also dynamically adjust shooting parameters of the camera assembly 1906 according to the ambient light intensity acquired by the optical sensor 1915.

The proximity sensor 1915, also referred to as a distance sensor, is generally provided on the front panel of the computer device 1900. The proximity sensor 1916 is used for acquiring a distance between the user and the front surface of the computer device 1900. In one embodiment, when the proximity sensor 1916 detects that the distance between the user and the front surface of the computer device 1900 gradually decreases, the processor 1901 controls the display screen 1905 to switch from a screen-off state to a screen-on state; when the proximity sensor 1916 detects that the distance between the user and the front surface of the computer device 1900 gradually increases, the processor 1901 controls the display screen 1905 to switch from a screen-off state to a screen-on state.

A person skilled in the art may understand that the structure shown in FIG. 19 constitutes no definition on the computer device 1900, and the computer device may include more or fewer components than those shown in the figure, or some components may be combined, or arrangement is made by using different components.

The embodiments of this disclosure also provide a computer device, which can be implemented as a terminal or a server as shown in FIG. 2. The computer device includes a processor and a memory, a computer program is stored in the memory, and the computer program is loaded and executed by the processor so as to implement the above lane indication method.

The embodiments of this disclosure also provide a computer-readable storage medium, a computer program is stored in the computer-readable storage medium, and the computer program is loaded and executed by a processor so as to implement the above lane indication method.

In some embodiments, the computer-readable medium may include: a read-only memory (ROM), a random access memory (RAM), a solid state drive (SSD), an optical disc, or the like. The random access memory may include a resistance random access memory (ReRAM) and a dynamic random access memory (DRAM). The sequence numbers of the foregoing embodiments of this disclosure are merely for description purposes but do not imply the preference among the embodiments.

A person of ordinary skill in the art may understand that all or some of the steps of the above embodiments may be implemented by hardware, or may be implemented by a program instructing relevant hardware. The program may be stored in a computer-readable storage medium. The storage medium mentioned above may be a read-only memory, a magnetic disk, an optical disc, or the like.

The embodiments of this disclosure also provide a computer program product or computer program, where the computer program product or computer program includes computer instructions, and the computer instructions are stored in a computer-readable storage medium. The processor of the computer device reads the computer instructions from the computer readable storage medium, and the processor executes the computer instructions, so that the computer device executes the lane indication method described above.

Notably, the information (including but not limited to target device information, target personal information, etc.) involved in this disclosure, data (including but not limited to data used for analysis, stored data, displayed data, etc.) and signals are all authorized by the target or fully authorized by all parties, and the collection, use and processing of relevant data need to comply with relevant laws, regulations and standards of relevant countries and regions. For example, the navigation start position, navigation end position, navigation route, historical driving data, etc. mentioned in this disclosure are all obtained under the condition of sufficient authorization.

The foregoing descriptions are merely example embodiments of this disclosure, and are not intended to limit this disclosure. Any modification, equivalent replacement, or improvement made within the spirit and principle of this disclosure shall fall within the protection scope of this disclosure.

What is claimed is:

1. A lane indication method, executed by a terminal device and comprising:
in response to a navigation start operation, displaying a navigation interface, wherein the navigation start operation indicates performing navigation based on a navigation start position and a navigation end position, the navigation interface is configured to display a navigation route, and the navigation route comprises at least one intersection; and
in response to being within a prompt range of a current intersection, providing lane prompt information corresponding to the current intersection and lane prompt information corresponding to a subsequent intersection of the current intersection.

2. The method according to claim 1, further comprising:
determining a first presentation mode of the lane prompt information corresponding to the current intersection, the first presentation mode comprising at least one of an information type or a presentation form of the lane prompt information corresponding to the current intersection;
determining a second presentation mode of the lane prompt information corresponding to the subsequent intersection, the second presentation mode comprising at least one of the information type or the presentation form of the lane prompt information corresponding to the subsequent intersection;
wherein the lane prompt information corresponding to the current intersection is displayed in the first presentation mode and the lane prompt information corresponding to the subsequent intersection is displayed in the second presentation mode.

3. The method according to claim 2, wherein the information type comprises at least one of:
lane pointing information, recommended lane information, a distance between an intersection and a designated location, a lane traffic condition or a speed limit requirement;
wherein the lane pointing information of an intersection refers to lane distribution information corresponding to the intersection, and the recommended lane information of an intersection indicates a recommended lane corresponding to the intersection in the navigation route.

4. The method according to claim 1, wherein further comprising:
determining the subsequent intersection whose land prompt information is to be displayed based on an intersection display strategy; wherein the intersection display strategy is related to at least one of intersection distribution in the navigation route, a dynamic parameter of a driving process, and a static parameter of the driving process, the dynamic parameter being a parameter updated in real time according to the driving process and the static parameter being a parameter that remains unchanged during the driving process.

5. The method according to claim 1, wherein the subsequent intersection includes at least one of: a designated intersection after the current intersection, or one or more intersections determined based on at least one of: driving parameters, an intersection positional relationship, parameters of the display screen, a navigation phase, or traffic flow corresponding to the navigation route.

6. The method according to claim 1, wherein the subsequent intersection includes one or more designated intersections after the current intersection; and
the providing lane prompt information corresponding to the current intersection and lane prompt information corresponding to a subsequent intersection of the current intersection comprises:
providing lane prompt information corresponding to the current intersection and lane prompt information corresponding to the one or more designated intersection, wherein the one or more designated intersection is a next intersection of the current intersection, at least two intersections after the current intersection, or an intersection meeting specified conditions after the current intersection.

7. The method according to claim 1, wherein the subsequent intersection is determined based on a driving speed;
the providing lane prompt information corresponding to the current intersection and lane prompt information corresponding to subsequent intersection of the current intersection comprises:
based on the driving speed, providing lane prompt information corresponding to the current intersection and lane prompt information corresponding to a first number of subsequent intersections after the current intersection, wherein the first number has a positive correlation relationship with the driving speed.

8. The method according to claim 1, wherein the subsequent intersection is determined based on a parameter of a driving gear;
the providing lane prompt information corresponding to the current intersection and lane prompt information corresponding to subsequent intersection of the current intersection comprises:
based on the parameter of the driving gear, providing lane prompt information corresponding to the current intersection and lane prompt information corresponding to a second number of subsequent intersection after the current intersection, wherein different parameters of the driving gear correspond to different second numbers.

9. The method according to claim 1, wherein the subsequent intersection is determined based on an intersection positional relationship;
the providing lane prompt information corresponding to the current intersection and lane prompt information corresponding to subsequent intersection of the current intersection comprises:
determining a third number of subsequent intersections based on the distance between the current intersection and the subsequent intersection; and
based on a distance between the current intersection and the subsequent intersection, providing lane prompt information corresponding to the current intersection and lane prompt information corresponding to the third number of subsequent intersections.

10. The method according to claim 9, wherein the determining a third number of subsequent intersections based on the distance between the current intersection and the subsequent intersection comprises:
determining a subsequent intersection whose distance from the current intersection meets the first distance requirement as one of the third number of subsequent intersections;
or determining, among the current intersection and one or more subsequent intersections, two adjacent intersections whose distance meets the second distance requirement, and including at least one of the two adjacent intersections which is not the current interaction to the third number of subsequent intersections.

11. The method according to claim 10, wherein
at least one of the first distance requirement or the second distance requirement comprises a preset distance threshold range, or a distance threshold range determined according to historical driving data.

12. The method according to claim 1, wherein the subsequent intersection is determined based on a size of the display screen;
the providing lane prompt information corresponding to the current intersection and lane prompt information corresponding to subsequent intersection of the current intersection comprises:
based on the size of the display screen, providing lane prompt information corresponding to the current intersection and lane prompt information corresponding to a fourth number of subsequent intersection after the current intersection, wherein the fourth number is in a positive correlation relationship with the size of the display screen.

13. The method according to claim 1, wherein the subsequent intersection is determined based on a navigation phase;
the providing lane prompt information corresponding to the current intersection and lane prompt information corresponding to subsequent intersection of the current intersection comprises:
based on the navigation phase, providing lane prompt information corresponding to the current intersection and lane prompt information corresponding to a fifth number of subsequent intersection after the current intersection, wherein the navigation phase is one of a plurality of navigation phases divided according to preset division rules, and different navigation phases correspond to different fifth numbers.

14. The method according to claim 1, wherein the providing lane prompt information corresponding to the current intersection and lane prompt information corresponding to subsequent intersection of the current intersection comprises:
displaying a first prompt box corresponding to the current intersection, the first prompt box being configured to display the lane prompt information of the current intersection, the first prompt box comprising a first lane marking corresponding to the current intersection, and the first lane marking indicating lane distribution of the current intersection;
displaying a second prompt box corresponding to the subsequent intersection, the second prompt box being configured to display the lane prompt information of the subsequent intersection, the second prompt box comprising a second lane marking corresponding to the subsequent intersection, and the second lane marking indicating the lane distribution of the subsequent intersection.

15. The method according to claim 14, wherein the displaying a second prompt box corresponding to the subsequent intersection comprises:
in response to the subsequent intersection being a next intersection of the current intersection, displaying the second prompt box at a preset location around the first prompt box;
or in response to the subsequent intersection comprising at least two intersections after the current intersection, sequentially arranging and displaying the second prompt boxes respectively corresponding to the at least two intersections at the preset location around the first prompt box.

16. The method according to claim 15, wherein
when the subsequent intersection is a next intersection of the current intersection, a display size of the second prompt box is smaller than a display size of the first prompt box.

17. The method according to claim 15, wherein
when the subsequent intersection comprises at least two intersections after the current intersection, the second prompt boxes respectively corresponding to the at least two intersections have a same display size, and the display size of the second prompt boxes is smaller than the display size of the first prompt box;
or when the subsequent intersection comprises at least two intersections after the current intersection, the display sizes of the second prompt boxes respectively corresponding to the at least two intersections gradually decrease with an arrangement order of the at least two intersections;
or when the subsequent intersection comprise n intersections after the current intersection, the second prompt boxes corresponding to first i subsequent intersections after the current intersection are displayed in a first size, the second prompt boxes corresponding to the (i+1)^{th} to n^{th} subsequent intersection are displayed in a second size, wherein the first size is smaller than the display size of the first prompt box, the second size is smaller than the first size, n≥2, i is a positive integer, and i≤n.

18. The method according to claim 15, further comprising at least one of:
in the first prompt box, highlighting a first target lane marking, the first target lane marking being a marking of a recommended lane corresponding to the navigation route in the first lane marking; or
in the second prompt box, highlighting a second target lane marking, the second target lane marking being a marking of a recommended lane corresponding to the navigation route in the second lane marking.

19. A lane indication apparatus, comprising:
at least one processor and at least one memory, wherein a computer program is stored in the at least one memory, the computer program being loaded and executed by the at least one processor to implement:
in response to a navigation start operation, displaying a navigation interface, wherein the navigation start operation indicates performing navigation based on a navigation start position and a navigation end position, the navigation interface is configured to display a navigation route, and the navigation route comprises at least one intersection; and
in response to being within a prompt range of a current intersection, providing lane prompt information corresponding to the current intersection and lane prompt information corresponding to a subsequent intersection of the current intersection.

20. A non-transitory computer readable storage medium, wherein a computer program is stored in the storage medium, the computer program being loaded and executed by at least one processor to implement:
in response to a navigation start operation, displaying a navigation interface, wherein the navigation start operation indicates performing navigation based on a navigation start position and a navigation end position, the navigation interface is configured to display a navigation route, and the navigation route comprises at least one intersection; and
in response to being within a prompt range of a current intersection, providing lane prompt information corresponding to the current intersection and lane prompt information corresponding to a subsequent intersection of the current intersection.
